(19) United States
(12) Patent Application Publication
(10) Pub. No.: US 2025/0158113 A1
(43) Pub. Date: May 15, 2025

(54) Sulfide Based All-Solid-State Batteries Enabled by Bipolar Stacking

(71) Applicant: Northeastern University, Boston, MA (US)

(72) Inventors: Hongli Zhu, Newton, MA (US); Daxian Cao, Malden, MA (US)

(21) Appl. No.: 18/839,319

(22) PCT Filed: Feb. 14, 2023
(86) PCT No.: PCT/US2023/062541

§ 371 Date: Aug. 16, 2024

Related U.S. Application Data
(60) Provisional application No. 63/268,220, filed on Feb. 18, 2022.

(51) Int. Cl. H01M 10/0562; H01M 4/02; H01M 4/04; H01M 4/134; H01M 4/1391; H01M 4/36; H01M 4/38; H01M 4/525; H01M 4/62; H01M 4/66; H01M 10/0585

(52) U.S. Cl. CPC H01M 10/0562; H01M 4/0404; H01M 4/134; H01M 4/1391; H01M 4/366; H01M 4/386; H01M 4/525; H01M 4/622; H01M 4/669; H01M 10/0585; H01M 2004/021; H01M 2004/027; H01M 2004/028; H01M 2300/008

(57) ABSTRACT

Described herein is an all-solid-state battery comprising two or more mono cells connected in series, wherein: each mono cell comprises a lithium-based cathode, a sulfide solid electrolyte, and an anode; and adjacent mono cells are connected through a single, shared current collector in contact with a cathode and an anode of adjacent mono cells. The all-solid-state battery can be fabricated by stacking freestanding layers of the lithium-based cathode, the sulfide solid electrolyte, the anode, and the current collector in a bipolar design, and pressing the layers together to form the all-solid-state battery. The lithium-ion battery -can be incorporated into portable electronics and electric vehicles.

### RELATED APPLICATION

This application claims the benefit of U.S. Provisional Application No. 63/268,220, filed on Feb. 18, 2022. The entire teachings of this application are incorporated herein by reference.

### GOVERNMENT SUPPORT

This invention was made with government support under Grant No. 1924534 awarded by the National Science Foundation. The government has certain rights in the invention.

### BACKGROUND

All solid-state lithium batteries (ASLBs) using solid-state electrolytes (SEs) have prospectively higher energy densities than conventional lithium-ion batteries (LIBs) using organic liquid electrolytes. In addition to increasing the energy density in ASLBs by optimizing materials and structures in a single galvanic cell, a particular bipolar stacking design can deliver higher energy densities but lack attention. In industrial applications, like electric vehicles (EVs), batteries are packed either in series or parallel to maximize power and energy. In a conventional LIBs system, each unit cell is sealed separately to avoid the leakage and internal ionic short circuit in the cell pack caused by the flowable liquid electrolyte. Therefore, many inactive materials, like the current collectors, packing materials, and wire tabs for external connections, are utilized in the battery system, significantly limiting the energy density and increasing the overall cost. It is essential to reduce the usage of inactive materials to reduce the weight and cost.

Bipolar stacking is a configuration for a battery pack where all the mono cells are connected in series through one current collector contacting two electrodes without external connections. The nonflowing SEs can avoid the internal ionic short circuit. On one side, the usage of inactive material can be further reduced when the adjacent cathode and anode share one current collector. Meanwhile, the packing materials can be minimized because all the cells can be packed inside one package. Furthermore, the shortened electron conduction paths between mono batteries result in lower resistance and increased power density. In addition, the bipolar-stacked ASLBs can deliver a high output voltage enabling versatile applications.

Currently, most reported bipolar-stacked ASLBs are based on solid polymer electrolytes or composite polymer electrolytes, in which the low ionic conductivity of SEs limits their performances for practical applications. Meanwhile, the polymer-based electrolytes can melt and flow when the ASLBs run at a high temperature, resulting in an ionic short. Given the high ionic conductivity (>1 mS cm⁻¹) and high thermal stability, sulfide SEs are one of the best candidates to fabricate bipolar-stacked ASLBs. However, sulfide SE-based bipolar-stacked ASLBs are rarely reported. The main challenge is fabricating compatible electrodes and SE layers with good film formability and mechanical strength to avoid the short circuit in cell fabrication.

Accordingly, there is a need for sulfide SE-based bipolar-stacked ASLBs.

### SUMMARY

Described herein is an all-solid-state battery comprising two or more mono cells connected in series, wherein: each mono cell comprises a cathode (e.g., a lithium-based cathode), a sulfide solid electrolyte, and an anode; and adjacent mono cells are connected through a single, shared current collector in contact with a cathode and an anode of adjacent mono cells.

Also described herein is a mono cell all-solid-state battery comprising first and second stainless steel current collectors, a cathode comprising single-crystal LiNi_{0.8}Mn_{0.1}Co_{0.1}O₂ coated with Li₂SiOₓ, wherein x is about 1 to about 3, a sulfide solid electrolyte, and an anode, wherein the first stainless steel current collector is in contact with the cathode, the cathode is in contact with the sulfide solid electrolyte, the sulfide solid electrode is in contact with the anode, and the anode is in contact with the second stainless steel current collector.

Also described herein is a system comprising an all-solid-state battery of any one of the all-solid-state batteries described herein connected to an energy source or an electrical device.

Also described herein is a method of fabricating a cathode (e.g., a lithium-based cathode), comprising: providing a dispersion of an amphipathic binder, Li₆PS5Cl, single-crystal LiNi_{0.8}Mn_{0.1}Co_{0.1}O₂ coated with Li₂SiOₓ wherein x is about 1 to about 3 in a solvent; and vacuum filtering the dispersion through a filter, thereby forming a layer of lithium-based cathode.

Also described herein is a method of fabricating an anode, comprising: providing a dispersion of an amphipathic binder, Si, Li₆PS5Cl, and carbon black in a solvent; and vacuum filtering the dispersion through a filter, thereby forming a layer of anode.

Also described herein is a method of fabricating an all-solid-state battery described herein, the method comprising stacking freestanding layers of lithium-based cathode, sulfide solid electrolyte, anode, and shared current collector in a bipolar design, and pressing the layers together to form the all-solid-state battery.

All solid-state lithium batteries (ALSBs) are regarded to deliver higher energy density and safety than conventional lithium-ion batteries (LiBs). The higher energy density was because of employing high energy electrodes and unique battery structure designs, like bipolar stacking. In contrast to the conventional LiBs that are sealed separately and then packed together, the solid electrolyte (SE) enables ASLBs to be directly connected without extra packing materials. The bipolar stacking design could minimize the using of inactive material in the batteries resulting a greatly increased energy density. Moreover, if the batteries are connected in series, a high voltage output could be obtained. In addition, the adjacent ASLBs could share one current collector. The shortened electron conduction paths between cells benefit lower resistance and increased power density. Sulfide SEs which are highlighted with ultrahigh ionic conductivity, are one of the most promising electrolytes to produce the bipolar stacked ASLBs. However, the report on sulfide based ASLBs is rare. The main reason is the lack of reliable laminated electrodes and electrolytes layers.

Sulfide SE-based ASLBs with a bipolar stacking design were successfully assembled. The previously reported bipolar ASLBs are mainly based on polymer electrolyte which shows a high risk of short circuit when tested at higher temperature. Meanwhile, the ionic conductivity is also challenging. This work sheds light of the great potential and merits of sulfide SE in bipolar ASLBs fabrication and accelerates the commercialization of sulfide SE based ASLBs in large scale manufacturing.

The cathode, anode, and electrolyte layers are laminated sheets that are freestanding, flexible, and robust. All these layers are fabricated through a vacuum filtration method based on a toluene-ethyl cellulose system which is highly compatible with sulfide SE. The bipolar design could be facilely realized through stacking the layers one by one followed by a uniaxial pressure, which greatly simplifies the processing of bipolar stacked ASLBs.

Advanced electrodes, including single-crystal NMC 811 and Si anode, are employed in the bipolar ASLBs. The single-crystal NMC 811 was coated with a thin LixSiO3 layer to stabilize the interface with sulfide SE. The Si anode was utilized because of its better compatibility with sulfide SE than Li metal anode and high energy density.

The bipolar stacked ASLBs deliver a high voltage of 8.2 V and a cell level high energy density of 204 Wh kg-1, which is higher than the 189 Wh kg⁻¹ of the ASLBs using conventional stacking.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the drawings included in the attached manuscript. The drawings are not necessarily to scale, emphasis instead being placed upon illustrating embodiments.

FIG. 1A shows the fabrication process of freestanding cathode, solid electrolyte (SE), and anode layers via vacuum filtration.

FIG. 1B shows the fabrication of bipolar stacked ASLBs through layer-by-layer stacking followed by pressing.

FIG. 1C shows certain merits of the high voltage bipolar-stacked ASLBs and composition distribution in each layer.

FIG. 2A is a photograph of a cathode layer.

FIG. 2B shows x-ray diffraction (XRD) pattern comparison among cathode layer and solid electrolyte and NMC components.

FIG. 2C shows tensile strength of the cathode layer.

FIG. 2D is a cross-section scanning electron microscopy (SEM) image of the cathode layer at x800 magnification.

FIG. 2E is a cross-section SEM image of the cathode layer at x5,000 magnification.

FIG. 2F is a cross-section SEM image of the cathode layer at x10,000 magnification.

FIG. 2G shows energy dispersive x-ray spectroscopy (EDX) mapping of the cathode layer to show the distribution of nickel (Ni, purple color).

FIG. 2H shows EDX mapping of the cathode layer to show the distribution of carbon (C, blue color).

FIG. 2I shows EDX mapping of the cathode layer to show the distribution of sulfur (S, yellow color).

FIG. 2J shows charge and discharge profiles of the cathode layer.

FIG. 2K shows corresponding dQ/dV profiles of the cathode half-cell at the first three cycles.

FIG. 2L shows rate performance of the cathode half-cell.

FIG. 3A is a photograph of an anode layer.

FIG. 3B shows XRD pattern comparison among anode layer and Si and SE components.

FIG. 3C shows tensile strength of the anode layer.

FIG. 3D is a cross-section SEM image of the anode layer at x2,000 magnification.

FIG. 3E is a cross-section SEM image of the anode layer at x50,000 magnification.

FIG. 3F is a cross-section SEM image of the anode layer at x80,000 magnification.

FIG. 3G shows EDX mapping of the anode layer to show the distribution of silicon (Si, green color).

FIG. 3H shows EDX mapping of the anode layer to show the distribution of carbon (C, blue color).

FIG. 3I shows EDX mapping of the anode layer to show the distribution of sulfur (S, yellow color).

FIG. 3J shows charge and discharge profiles of the anode layer.

FIG. 3K shows corresponding dQ/dV profiles of the anode half-cell at the first three cycles.

FIG. 3L shows rate performance of the anode half-cell.

FIG. 4A shows a schematic of the mono cell with lamination structure.

FIG. 4B is a photograph of the freestanding cathode, SE, and anode layers used for full cell assembly.

FIG. 4C is an SEM image to show the cross-section morphology of the mono cell.

FIG. 4D shows EDX mapping images of the cross-section morphology of the mono cell (Si is shown with green color; S is shown with yellow color; and Ni is shown with pink color).

FIG. 4E shows charge and discharge profiles of the mono cell.

FIG. 4F shows dQ/dV curves of the mono cell in the initial three cycles at the current rate of 0.1 Coulomb (C).

FIG. 5A shows a schematic illustration of a conventional stacked LiB using a liquid electrolyte.

FIG. 5B shows a schematic illustration of a conventional stacked ASLB.

FIG. 5C shows a schematic illustration of a bipolar stacked ASLB.

FIG. 5D shows charge and discharge profiles of a bipolar stacked ASLB.

FIG. 5E shows dQ/dV profiles at the first three cycles of the bipolar stacked ASLB. The inset illustrates the architecture of the bipolar stacked ASLB.

FIG. 5F shows Nyquist plots before and after the first three cycles of the bipolar stacked ASLB.

FIG. 5G shows rate performances at the current rate of C/10, C/5, C/2, and 1C.

FIG. 5H shows the cycling performance at the current rate of C/3.

FIG. 6 shows the gravimetric energy density comparison between the bipolar stacked ASLBs and conventional stacked ASLBs.

FIG. 7A is photographs of the cathode composite dispersed in toluene with ethyl cellulose (left) and without ethyl cellulose (right).

FIG. 7B is photographs of the anode composite dispersed in toluene with ethyl cellulose (left) and without ethyl cellulose (right).

FIG. 8A is an SEM image of Li₂SiOx@S-NMC at a magnitude of ×5,000.

FIG. 8B is an SEM image of Li₂SiOx@S-NMC at a magnitude of ×30,000.

FIG. 9A is an SEM image of the cathode layer at a magnitude of ×500,000 after rate performance test.

FIG. 9B is an SEM image of the cathode layer at a magnitude of ×7,000 after rate performance test.

FIG. 10 shows the galvanostatic charge and discharge profiles of the cathode layer without adding binder in half-cell at a current rate of C/20.

FIG. 11 is a photograph of the anode layer with 2 weight percent (wt %) ethyl cellulose.

FIG. 12A is an SEM image of Si nanoparticles at a magnitude of ×20,000.

FIG. 12B is an SEM image of Si nanoparticles at a magnitude of ×200,000.

FIG. 13 shows the galvanostatic charge and discharge profiles of the Si anode without adding binder in half cell at current density of 0.1 mA cm².

FIG. 14A is an SEM image of the cathode layer at a magnitude of ×1.5×10′ after rate performance test.

FIG. 14B is an SEM image of the cathode layer at a magnitude of ×30,000 after rate performance test.

### DETAILED DESCRIPTION

A description of example embodiments follows.

High voltage ASLBs with a bipolar design based on sulfide SE have been fabricated successfully and described herein. Benefiting from the amphipathic property, high binding capability, excellent compatibility with sulfide SE, and high thermal stability, the ethyl cellulose binder enables the successful fabrication of freestanding, robust, and thickness-controllable cathode, SE, and anode layers through vacuum filtration. An interface stabilized high voltage single-crystal LiNi_{0.8}Mn_{0.1}Co_{0.1}O₂ (S-NMC) and nano Si were utilized separately as cathode and anode active material. The corresponding electrochemical performances of the obtained electrode layers have been investigated. Then the mono cell and bipolar-stacked double-layer cell were fabricated, and the electrochemical performances were evaluated. This could enlighten the research interest in investigating bipolar-stacked ASLBs and accelerates the development of ASLBs from lab scale to industrial manufacturing.

As used herein, singular articles such as “a,” “an” and “the,” and similar referents are to be construed to cover both the singular and the plural, unless otherwise indicated herein or clearly contradicted by context. For example, reference to “an all-solid-state battery” may refer to one or more all-solid-state batteries. When a referent refers to the plural, the members of the plural can be the same as or different from one another.

“About” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, e.g., ±10%, ±5% or 1% of a given value. It is to be understood that the term “about” can precede any particular value specified herein, except for particular values used in the Exemplification.

### Bipolar Stacked All-Solid-State Batteries

Described herein is an all-solid-state battery comprising two or more mono cells connected in series, wherein: each mono cell comprises a cathode (e.g., a lithium-based cathode), a sulfide solid electrolyte, and an anode; and adjacent mono cells are connected through a single, shared current collector in contact with a cathode and an anode of adjacent mono cells.

As used herein, the term “all-solid-state battery” refers to a battery in which the cathode, electrolyte, and anode are all in solid forms.

As used herein, the term “mono cell” or “single cell” refers to a single cathode in contact with an electrolyte which in turn is in contact with a single anode. A mono cell may also further comprise current collectors that are in contact with the cathode and anode. Mono cells may be connected to one another in series or in parallel to form a larger battery.

As used herein, the phrase “in series” refers to mono cells connected in series, wherein the negative terminal or electrode of one battery or mono cell is connected to the positive terminal or electrode of another and so on. There may be a shared current collector between the mono cells, as described above.

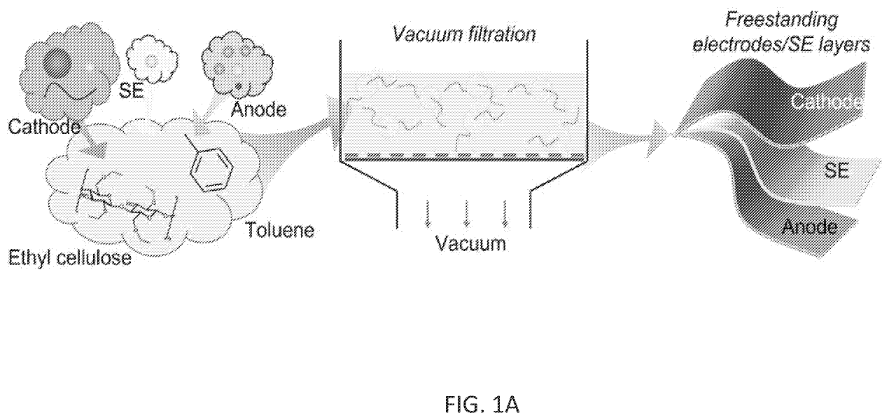

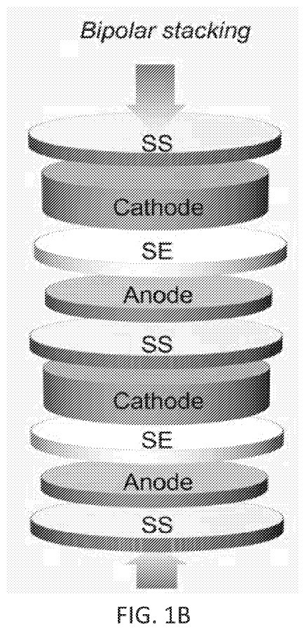

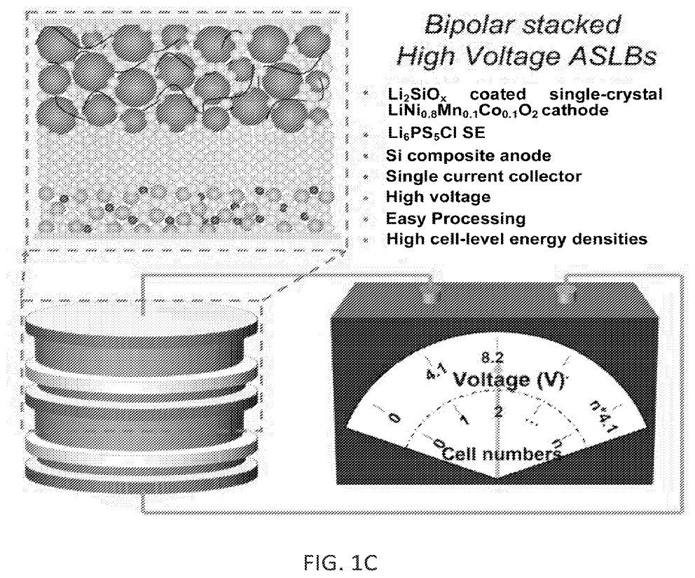

In some aspects, the two or more mono cells are arranged uniaxially, as depicted, for example, in FIG. 1B.

In some aspects, the all-solid-state battery further comprises an anode current collector in contact with an anode of a first mono cell in series, and a cathode current collector in contact with a cathode of a last mono cell in series.

As used herein, the term “cathode” refers to the battery electrode in which the reduction half-reaction occurs. Examples of cathode materials include: sulfur, Li metal oxides, polyanion oxides, stainless steel, LiNixMnyCozO2 where x+y+z is about 1 such as LiNi_{0.8}Mn_{0.1}Co_{0.1}O₂ (NMC811), LiNi_{0.06}Mn_{0.2}Co_{0.2}O₂ (NMC622), LiNi_{0.333}Mn_{0.333}Co_{0.33302} (NMC111), and LiFePO₄. In some aspects, the cathode comprises, consists of or consists essentially of (e.g., comprises) sulfur, Li metal oxides, polyanion oxides, stainless steel, LiNiₓMn_{y}Co_{z}O₂ where x+y+z is about 1 such as LiNi_{0.8}Mn_{0.1}Co_{0.1}O₂ (NMC811), LiNi_{0.06}Mn_{0.2}Co_{0.2}O₂ (NMC622), LiNi_{0.333}Mn_{0.333}Co_{0.33302} (NMC111), or LiFePO₄, or any combination thereof. In some aspects, the cathode is a lithium-based cathode. In some aspects, the lithium-based cathode comprises LiNi_{0.8}Mn_{0.1}Co_{0.1}O₂ (e.g., single-crystal LiNi_{0.8}Mn_{0.1}Co_{0.1}O₂).

Surface coating a cathode, such as a lithium-based cathode, can improve the stability of a battery in accordance with the instant disclosure as, for example, by protecting the solid electrolyte from degradation resulting from contact of the solid electrolyte with the lithium-based cathode. Accordingly, in some aspects, the cathode has a surface coating. Examples of cathode surface coatings can include: LiNbO3, metal oxides that are Li-containing or Li-ion conducting, or Li₂SiOₓ wherein x is about 1 to about 5 (e.g., about 1 to about 3). In some aspects, the cathode surface coating comprises, consists of or consists essentially of (e.g., comprises) LiNbO3 or Li₂SiOₓ wherein x is about 1 to about 5 (and, in preferred aspects, about 1 to about 3). In some aspects, the cathode surface coating comprises, consists of or consists essentially of (e.g., comprises) Li₂SiOₓ wherein x is about 1 to about 5 (and, in preferred aspects, about 1 to about 3).

In some aspects, the cathode (e.g., the lithium-based cathode) comprises LiNi_{0.8}Mn_{0.1}Co_{0.1}O₂ (e.g., single-crystal of LiNi_{0.8}Mn_{0.1}Co_{0.1}O₂) coated with Li₂SiOₓ, wherein x is about 1 to about 3. In some aspects, the cathode (e.g., the lithium-based cathode) comprises LiNi_{0.8}Mn_{0.1}Co_{0.1}O₂ (e.g., single-crystal of LiNi_{0.8}Mn_{0.1}Co_{0.1}O₂) coated with Li₂SiOₓ, wherein x is an integer from 1 to 3. In some aspects, the cathode (e.g., the lithium-based cathode) further comprises an amphipathic binder. In some aspects, the amphipathic binder is an alkyl cellulose, such as ethyl cellulose or methyl cellulose. In some aspects, the cathode (e.g., the lithium-based cathode) further comprises ethyl cellulose.

In some aspects, the cathode (e.g., lithium-based cathode) is in the form of a layer. In some aspects, the cathode (e.g., layer of cathode) has a thickness of about 50 μm to about 200 μm. In some aspects, the cathode (e.g., layer of cathode) has a thickness of about 50 μm to about 150 μm. In some aspects, the cathode (e.g., layer of cathode) has a thickness of about 50 μm to about 100 μm. In some aspects, the cathode (e.g., layer of cathode) has a thickness of about 75 μm to about 100 μm. In some aspects, the cathode (e.g., layer of cathode) has a thickness of about 96 μm.

As used herein, the term “electrolyte” refers to a material that transfers ions or charge carrying particles between a battery's electrodes. The electrolyte can be a solid or liquid. Examples of electrolytes include: Li₆PS5Cl, Li₇La₃Zr₂O₁₂ (LLZO), Li_{6.4}La₃Zr_{1.4}Ta_{0.6}O₁₂ (LLZTO), Li₃InCl₆, metal hydroxides, LiPF₆, sodium chloride, nitric acid, sulfuric acid, sodium acetate, chloric acid, ion-conducting polymers, and Al₂O₃containing materials. In some aspects, the electrolyte is a sulfide solid electrolyte. Examples of sulfide solid electrolytes include: mixtures comprising Li₂S and sulfides (such as P₂S₅, SiS₂, P₂S₅, GeS₂), Li₁₀GeP₂Si₂, and Li₆PSSXwhere X=Cl, Br or I. In some aspects, the sulfide solid electrolyte comprises Li₆PSsXwhere X=Cl, Br or I, e.g., Li₆PSSCl.

In some aspects, the solid electrolyte further comprises an amphipathic binder. In some aspects, the amphipathic binder is an alkyl cellulose, such as ethyl cellulose or methyl cellulose. In some aspects, the solid electrolyte further comprises ethyl cellulose.

In some aspects, the sulfide solid electrolyte is in the form of a layer. In some aspects, the sulfide solid electrolyte (e.g., layer of sulfide solid electrolyte) has a thickness of about 20 μm to about 1 millimeter, e.g., about 20 μm to about 500 μm, about 20 μm to about 400 μm, about 20 μm to about 250 μm, about 20 μm to about 100 gm, or about 35 μm to about 75 gm. In some aspects, the sulfide solid electrolyte (e.g., layer of sulfide solid electrolyte) has a thickness of about 20 μm to about 55 gm. In some aspects, the sulfide solid electrolyte (e.g., layer of sulfide solid electrolyte) has a thickness of about 47 μm.

In some aspects, the sulfide solid electrolyte is configured to inhibit edge shorting of the battery. For example, in some aspects, lateral size of the sulfide solid electrolyte is greater than lateral size of the lithium-based cathode and lateral size of the anode. Such a configuration is depicted, for example, in FIG. 1B, which shows an embodiment of a battery in accordance with the instant disclosure comprising two or more mono cells composed of circular or substantially circular layers arranged uniaxially, wherein the solid electrolyte has a radius that is greater than the radius of the cathode and the anode.

As used herein, the term “anode” refers to the battery electrode in which the oxidation half-reaction occurs. Examples of anode materials includes: silicon (Si), graphite, alloys comprising tin, cobalt, magnesium, silver, aluminum, and/or antimony, Li₄TisO₁₂, amorphous carbon, silicon/carbon alloy, lithium oxalates, Li₂CO₃, lithium (Li) metal or foil, or a mixture comprising Si, carbon (C) containing material, and an electrolyte. It will be appreciated by a person skilled in the art that when sulfur is used as the cathode material, the anode material should be lithium-based, such as lithium metal or foil or a pre-lithiated material. In some aspects, the anode comprises, consists of or consists essentially of silicon (Si), graphite, alloys comprising tin, cobalt, magnesium, silver, aluminum, and/or antimony, Li₄TisO₁₂, amorphous carbon, silicon/carbon alloy, lithium oxalates, Li₂CO₃, lithium (Li) metal or foil, or a mixture comprising Si, carbon (C) containing material, and an electrolyte, or any combination of the foregoing. In some aspects, the anode comprises Si (e.g., nano-silicon, micro-silicon), Li₆PS₅Cl, and carbon black. In some aspects, the anode is a mixture of nano-silicon (Si), Li₆PS₅Cl, and carbon black. In some aspects, the anode is a mixture of micro-silicon (Si), Li₆PS₅Cl, and carbon black. In some aspects, the anode mixture of nano-silicon (Si), Li₆PS₅Cl, and carbon black has a weight ratio of about 6:3:1.

In some aspects, the anode further comprises an amphipathic binder. In some aspects, the amphipathic binder is an alkyl cellulose, such as ethyl cellulose or methyl cellulose. In some aspects, the anode further comprises ethyl cellulose.

In some aspects, the anode is in the form of a layer. In some aspects, the anode (e.g., layer of anode) has a thickness of about 40 μm to about 100 μm. In some aspects, the anode (e.g., layer of anode) has a thickness of about 40 μm to about 75 μm. In some aspects, the anode (e.g., layer of anode) has a thickness of about 50 μm.

As used herein, the term “current collector” refers to a material used to conduct electrons between an electrode active material (such as an anode or cathode) and the battery terminals, or the anode of one mono cell to the cathode of another. A current collector can be individually an anode current collector, a cathode current collector, or a shared current collector. Examples of current collectors can include: aluminum (Al, typically used for cathode current collectors), copper (Cu, typically used for anode current collectors), or stainless steel, carbon paper, or carbon black. In some aspects, the shared current collector is carbon (e.g., carbon paper, carbon black) or stainless steel. In some aspects, the shared current collector is stainless steel.

In some aspects, the shared current collector is in the form of a layer. In some aspects, the shared current collector (e.g., layer of shared current collector) has a thickness of about 10 μm to about 50 μm. In some aspects, the shared current collector (e.g., layer of shared current collector) has a thickness of about 10 μm to about 25 μm. In some aspects, the shared current collector (e.g., layer of shared current collector) has a thickness of about 15 μm.

Also described herein is a mono cell all-solid-state battery comprising first and second stainless steel current collectors, a cathode comprising single-crystal LiNi_{0.8}Mn_{0.1}Co_{0.1}O₂ coated with Li₂SiOₓ, wherein x is about 1 to about 3, a sulfide solid electrolyte, and an anode, wherein the first stainless steel current collector is in contact with the cathode, the cathode is in contact with the sulfide solid electrolyte, the sulfide solid electrode is in contact with the anode, and the anode is in contact with the second stainless steel current collector.

Also described herein is an all-solid-state battery that delivers a laboratory scale output voltage of at least about 4.1 V per mono cell.

Energy density refers to the measure of how much energy a battery contains with respect to its mass or weight. In some aspects, the all-solid-state battery delivers a laboratory scale cell level energy density of at least about 180 Wh kg⁻¹ to about 300 Wh kg⁻¹ per mono cell.

Also described herein is a system comprising an all-solid-state battery of any one of the all-solid-state batteries described herein connected to an energy source or an electrical device.

Electric vehicles and portable electronics are example uses for embodiments of the high-voltage, sulfide-based, all solid-state batteries disclosed herein. Methods

Also described herein is a method of fabricating a cathode (e.g., a lithium-based cathode), comprising: providing a dispersion of an amphipathic binder, Li₆PS₅Cl, single-crystal LiNi_{0.8}Mn_{0.1}Co_{0.1}O₂ coated with Li₂SiOₓ wherein x is about 1 to about 3 in a solvent; and vacuum filtering the dispersion through a filter, thereby forming a layer of lithium-based cathode.

In some aspects, the method further comprises removing the layer of cathode (e.g., lithium-based cathode) from the filter to form a freestanding layer of cathode (e.g., lithium-based cathode). In some aspects, the method further comprises evaporating the solvent from the layer of cathode (e.g., lithium-based cathode) or freestanding layer of cathode (e.g., lithium-based cathode).

Examples of organic solvents include: alkyl solvents (such as hexanes, cyclohexane, pentanes, and the like), aromatic solvents (such as xylene, benzene, toluene, and the like), alcohols (such as acidic methanol, ethanol, and the like), esters, ethers, and ketones (such as diethyl ether, acetone, and the like), amines (such as dimethyl amine and the like), and nitrated and halogenated hydrocarbons (such as dichloromethane, acetonitrile, and the like), and polar aprotic solvents (such as 1-methyl-2-pyrrolidone (sometimes referred to herein as N-methylpyrrolidone, NMP), dimethylsulfoxide (DMSO), dimethylformamide (DMF) and the like). In some aspects, the organic solvent comprises a polar aprotic solvent (such as NMP, DMSO, DMF, and the like). In some aspects, the organic solvent comprises an aromatic solvent, such as an aromatic hydrocarbon solvent. In some aspects, the organic solvent comprises xylene or toluene, or a combination thereof.

In some aspects, the amphipathic binder is an alkyl cellulose, such as methyl cellulose or ethyl cellulose. In some aspects, the amphipathic binder is ethyl cellulose.

In some aspects, the amphipathic binder is about 1.0 weight percent (wt. %) to about 3.0 wt. % of the dispersion. In some aspects, the amphipathic binder is about 1.0 weight percent (wt. %) to about 2.0 wt. % of the dispersion. In some aspects, the amphipathic binder is about 1.0 weight percent (wt. %) to about 1.5 wt. % of the dispersion. In some aspects, the amphipathic binder is about 1.0 wt. % of the dispersion.

Also described herein is a method of fabricating an anode, comprising: providing a dispersion of an amphipathic binder, Si, Li₆PS₅Cl, and carbon black in a solvent; and vacuum filtering the dispersion through a filter, thereby forming a layer of anode.

In some aspects, the method further comprises removing the layer of anode from the filter to form a freestanding layer of anode.

In some aspects, the method further comprises evaporating the solvent from the layer of anode or freestanding layer of anode. In some aspects, the solvent is an organic solvent as described above.

In some aspects, the amphipathic binder is a binder as described above. In some aspects, the amphipathic binder is ethyl cellulose. In some aspects, the amphipathic binder is about 1.0 wt. % to about 5.0 wt. % of the dispersion. In some aspects, the amphipathic binder is about 2.0 wt. % to about 5.0 wt. % of the dispersion. In some aspects, the amphipathic binder is about 3.0 wt. % to about 5.0 wt. % of the dispersion. In some aspects, the amphipathic binder is about 3.5 wt. % to about 4.5 wt. % of the dispersion. In some aspects, the amphipathic binder is about 4.0 wt. % of the dispersion.

Without wishing to be bound by any particular theory, it is believed that the vacuum filtration approach to fabricating electrodes described herein enabled the formation of dense, freestanding electrodes, and minimized pores, such as solvent pores resulting from evaporation of solvent from electrodes produced by traditional cast and coat techniques.

Also described herein is a method of fabricating the all-solid-state battery described herein, the method comprising stacking freestanding layers of the cathode (e.g., the lithium-based cathode), the sulfide solid electrolyte, the anode, and the current collector in a bipolar design, and pressing the layers together to form the all-solid-state battery. The method of fabricating an all-solid-state battery can further comprise any of the methods described herein for fabricating a cathode and/or anode described herein.

In some aspects, pressing the layers together comprises applying a pressure of about 3 MPa to about 100 MPa to the layers. In some aspects, pressing the layers together comprises applying a pressure of about 50 MPa to the layers.

As used herein, the term “bipolar design” or “bipolar stacking” refers to a configuration for a battery pack or an all-solid-state battery where the mono cells are connected in series through one current collector contacting two electrodes without external connections.

### EXEMPLIFICATION

Compared to the lithium-ion batteries using organic liquid electrolyte, all solid-state lithium batteries (ASLBs) have the advantages of improved safety and higher energy density. Multilayered bipolar stacking in ASLBs can further improve the energy density by minimizing the use of inactive materials. However, it is highly challenging to fabricate bipolar stacked ASLBs because of lacking vigorous laminated electrodes and electrolyte, especially for sulfide solid electrolytes. This work successfully assembled bipolar stacked ASLBs with high voltage by facilely stacking freestanding and robust cathode, electrolyte, and anode sheets. More specifically, interface stabilized single-crystal LiNi_{0.8}Mn_{0.1}Co_{0.1}O₂, Li₆PS₅Cl, and nano Si act as cathode, electrolyte, and anode individually. Amphipathic ethyl cellulose plays a role as disperser during ink preparation and further as binder in the freestanding membrane. The doubly stacked ASLBs deliver a high voltage of 8.2 V and cell-level energy density of 204 Wh kg⁻¹ higher than the 189 Wh kg⁻¹ of the mono cell. In practical application, the energy density can be further effectively boosted by stacking multiple cells.

The following data has been published in Cao, D.; Sun, X.; Wang, Y.; Zhu, H., Bipolar stackings high voltage and high cell level energy density sulfide based all-solid-state batteries, Energy Storage Materials 2022, 48, 458-465, the entire content of which is incorporated herein by reference.

### Example 1: Design of Bipolar Stacked ASLBs

Robust electrodes and SE layers play important roles in bipolar stacked ASLBs fabrication. The electrodes and SE layers used for bipolar stacked ASLBs should have high integrity, well-controlled layer thickness/mass, and high robustness to benefit the stacking of many cells. However, in most studies on sulfide SEs, cold pressing is used to make thick pallets of electrode and SE, which have several limitations, including: difficulty obtaining a thin and uniform membrane resulting in an easy internal short circuit when stacking multiple cells; cold-pressed SE layers have high thickness/mass causing a limited cell-level energy density; size limitations; and any inconsistencies in each cell in bipolar stacked ASLBs highly determines the cycling stability and life. Meanwhile, it is challenging to accurately control each cell's consistency through cold pressing.

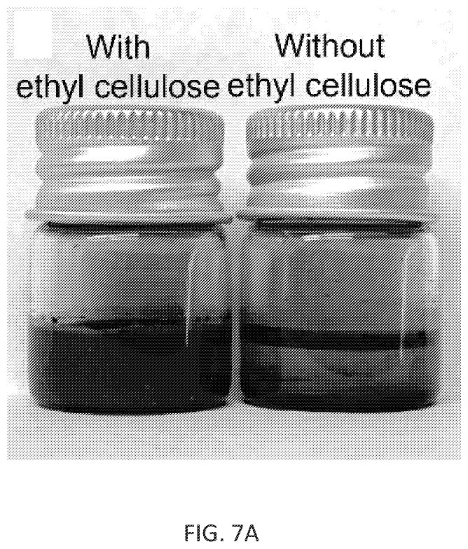

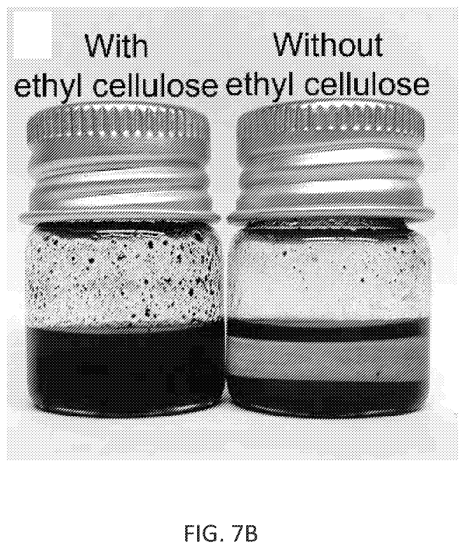

FIGS. 1A-C illustrate the overview of the bipolar stacked ASLBs described herein. Freestanding electrodes and SE layers were developed through a vacuum filtration method. Previous work successfully prepared an ultrathin SE membrane based on Li₆PS₅Cl with a low thickness of 47 m and areal resistance of 4.32 Q cm⁻². With the same method, the electrodes layers were fabricated. As presented in FIG. 1A, the cathode, SE, anode powders were separately well dispersed in the toluene with the assistance of amphipathic binder ethyl cellulose. The ethyl cellulose stabilized the cathode and anode composites dispersed in toluene and prevented precipitation, as shown in FIGS. 7A-B. Freestanding cathode, SE, and anode layers were successfully prepared through vacuum filtration and heated to remove the residual solvent. The layer thickness and mass loading of each layer were easily controlled by adjusting the mass of the materials for filtration. The electrodes and SE layers were then punched into discs with the desired size and stacked with high uniaxial pressure, as shown in FIG. 1B. To avoid edge shorting, the lateral size of the SE layer was a little larger than the cathode and anode layers. Stainless steel (SS) foil was selected as the bipolar plate because of its high electrical conductivity and good electrochemical stability in cathode and anode sides. FIG. 1C presents the bipolar stacked ASLBs and the detailed compositions in the mono cell. The advantage of bipolar stacked ASLBs is a high voltage, and the voltage value depends on the number of cells in stacking. For example, if the cell's voltage is 4.1 V, with double cells in series, the stack voltage is 8.2 V, as indicated in FIG. 1C. In the disclosed cells, high energy cathode and anode active materials were employed to boost the energy densities of the ASLBs. The cathode was based on a lithium silicate (Li₂SiOₓ) coated S-NMC (Li₂SiOx@S-NMC); the anode employed a Si composite; the thin SE membrane made of Li₆PS₅C1 was utilized. Both S-NMC and Si proved high energy. The resulting cells delivered a high output voltage and cell-level high energy densities through bipolar stacking.

### Example 2: Characterization of Cathode Layer

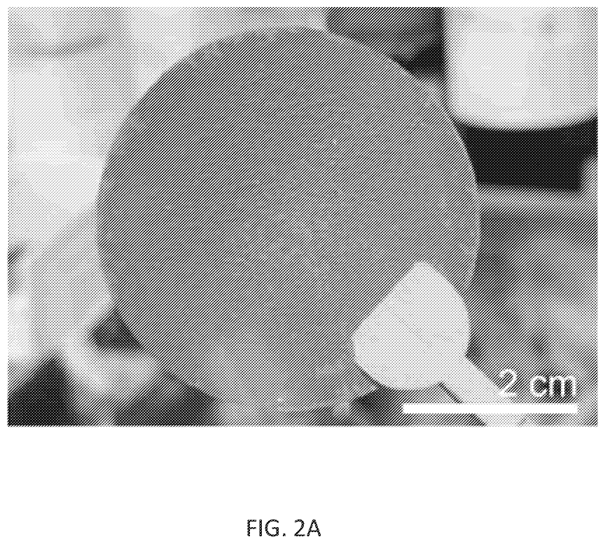

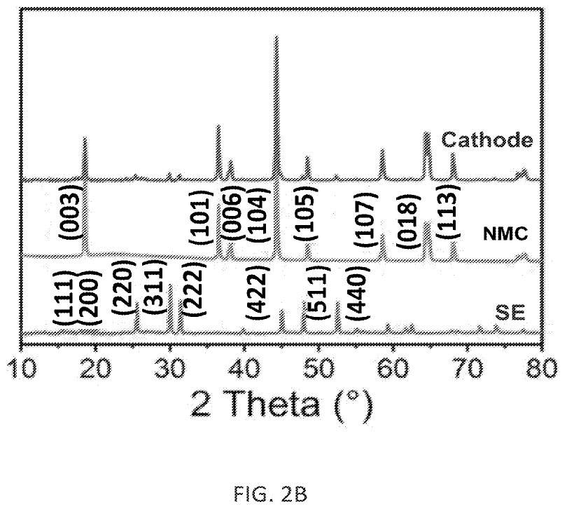

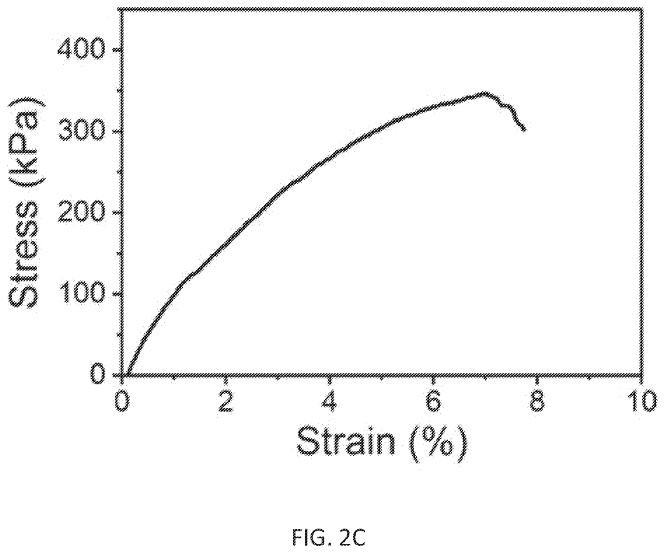

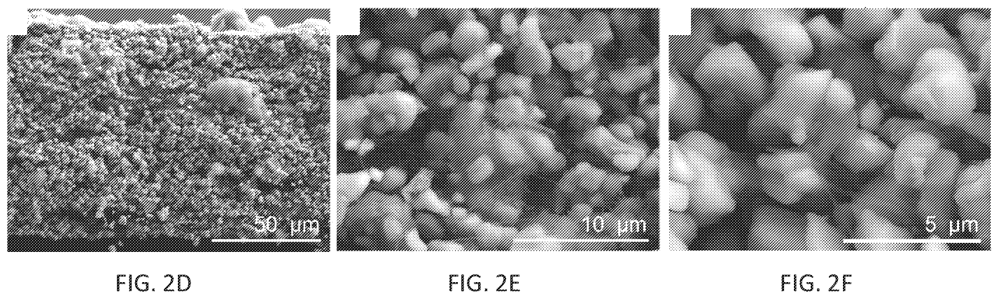

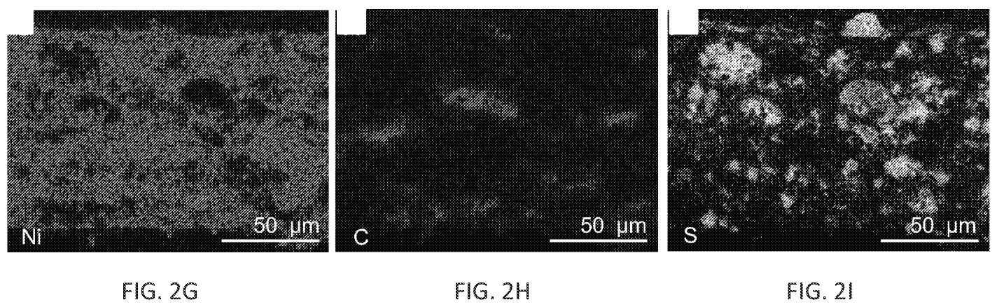

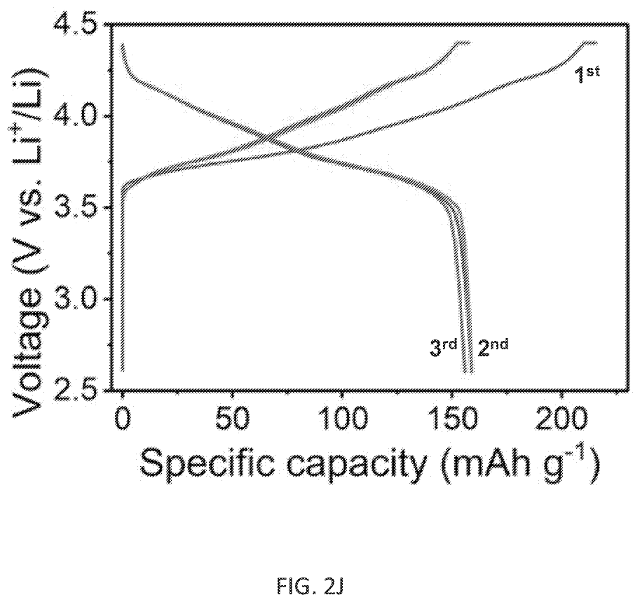

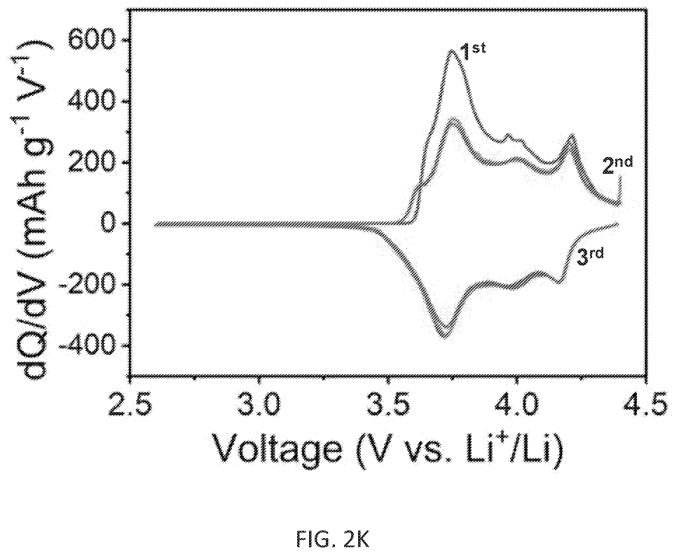

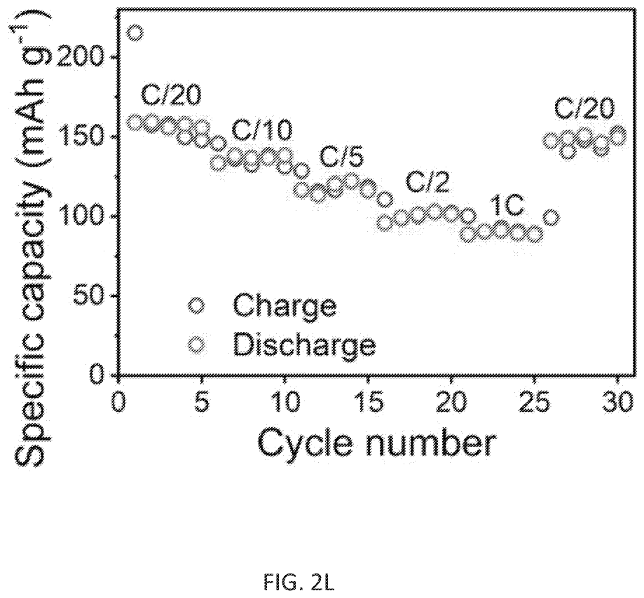

FIG. 2A displays the photo image of the as-prepared cathode layer. 1.0 wt. % fraction of ethyl cellulose enabled good binding ability and allowed the cathode layer to be freestanding. The lateral size of the cathode layer is 44 mm, which can be further enlarged by using a larger filtration setup. FIG. 2B compares the x-ray diffraction (XRD) patterns of the cathode layer with the pristine Li₂SiOₓ@S-NMC and Li₆PS₅Cl SE. All the peaks in the cathode were assigned to the S-NMC or Li₆PS₅Cl, and no newborn peaks were observed, suggesting the cathode processing process has no side reactions. The mechanical strength of the cathode layer was evaluated through the tensile test, as shown in FIG. 2C. A value of 347 kPa was obtained, which was sufficient in the following layers lamination and bipolar stacking.

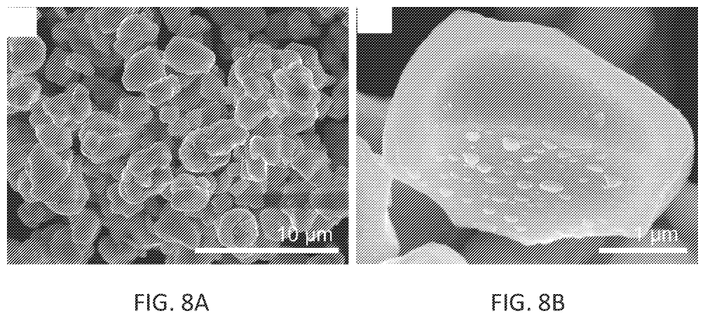

FIGS. 2D-F show the SEM images of the cathode layer with a thickness of about 96 μm. The mass loading was about 25 mg cm⁻². The S-NMC has an irregular morphology with an average particle size of about 3.8 m, as shown in FIGS. 8A-B. The homogeneous and stable dispersion of S-NMC, Li₆PS₅Cl, and vapor grown carbon fibers (VGCF) in toluene resulted in a uniform and well-controllable layer thickness. Energy dispersive x-ray (EDX) mapping of Ni, C, and S elements also demonstrated the uniform dispersion of S-NMC, VGCF, and Li₆PS₅C1 in the cathode layer (FIGS. 2G-I).

The electrochemical performance of the cathode layer was evaluated in a half cell with In-Li as the anode. FIG. 2J displays the charge and discharge profiles of the ASLB at C/20 in the first three cycles. There was a plateau starting from 3.63 V at the first charge process. In the following cycles, the plateaus were maintained with no obvious overpotential, demonstrating the Li₂SiOₓ stabilized the interface between S-NMC and Li₆PS₅Cl. High initial charge and discharge capacities of 215 and 159 mAh g⁻¹, respectively, were achieved with a high initial coulombic efficiency (ICE) of 74.0%. No obvious capacity decay was observed in the following two cycles. The corresponding dQ/dV profiles were plotted to reveal the phase transition of S-NMC during cycling, as depicted in FIG. 2K. Three couples of anodic and cathodic peaks observed at 3.75 and 3.72, 4.00 and 3.98, 4.21 and 4.16 V and were related to the phase transitions among monoclinic M, hexagonal Hi, H2, and H3. The profiles during discharge almost overlapped, suggesting stable cycling.

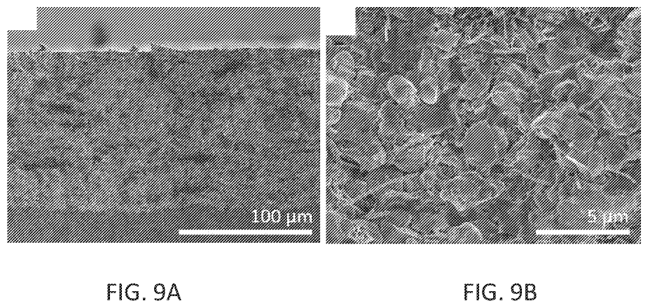

Then the rate performance of the cathode layer was investigated, as shown in FIG. 2L. The ASLB delivered average discharge capacities of 157, 136, 117, 100, and 89 mAh g⁻¹ at the rate of C/20, C/10, C/5, C/2, and 1C, respectively. The capacity recovered to 148 mAh g⁻¹ when recharged at C/20, evidencing an excellent rate performance and good cycling stability. FIGS. 9A-B shows the cross-section morphology of the cathode layer after the rate performance. The cathode maintained its integrity, and the mixture of NMC, SE, and VGCF was closely compacted. There was no delamination between the cathode and SE, suggesting excellent structure stability.

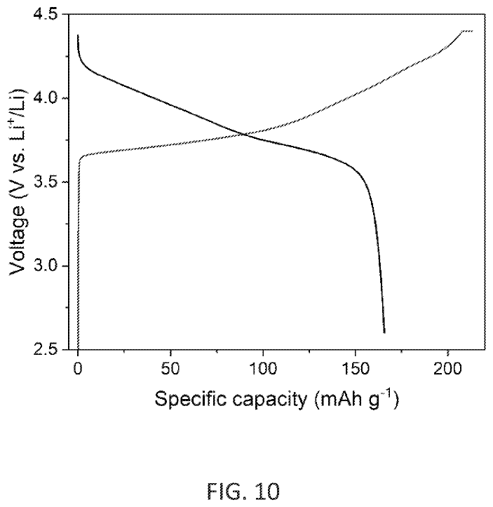

FIG. 10 displays the charge and discharge profiles of the ASLB using S-NMC cathode but without the addition of ethyl cellulose. At the current rate of C/20, the ASLB delivered initial charge and discharge capacities of 217 and 167 mAh g⁻¹ with a high ICE of 77.0%. The performance was slightly higher than the one without adding a binder, demonstrating that adding a binder can reduce the capacity to some extent. Due to the ionic insulating, the binder blocked the electrode's ion conduction, resulting in reduced performance.

### Example 3: Characterization of Anode Layer

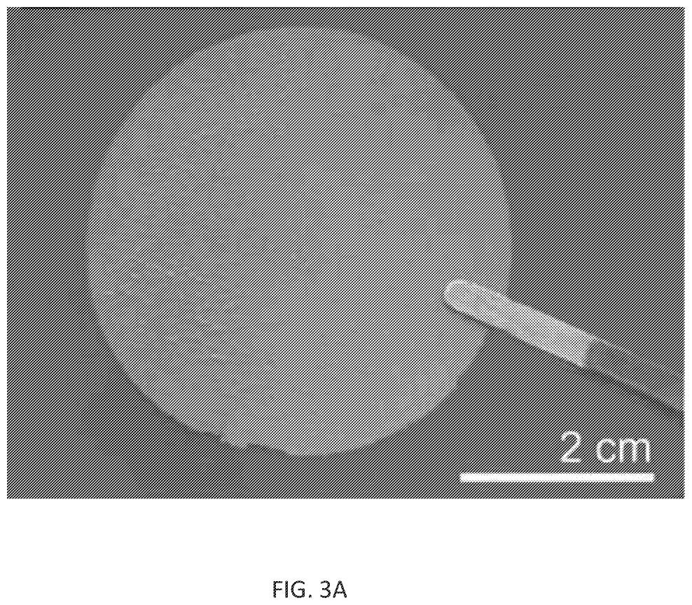

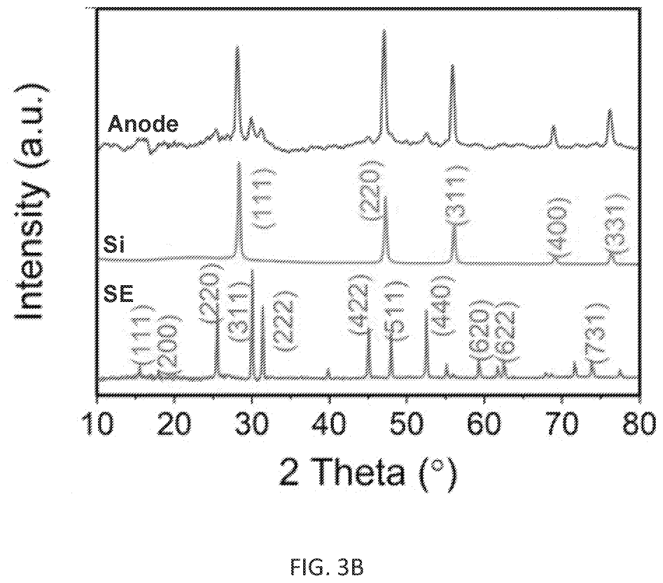

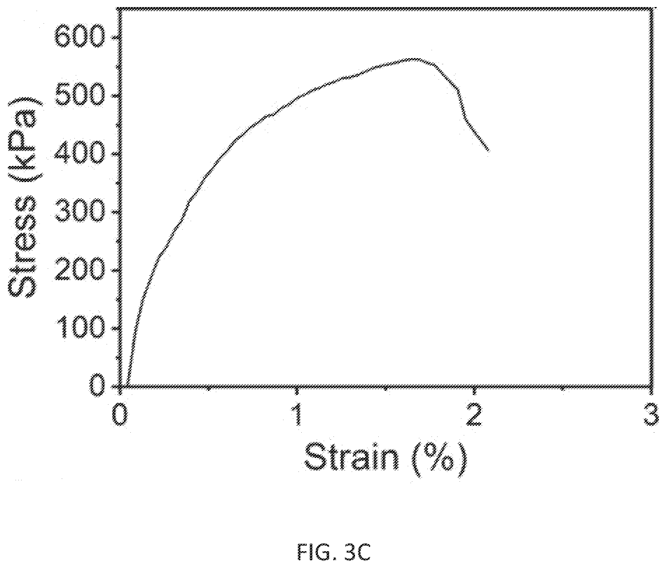

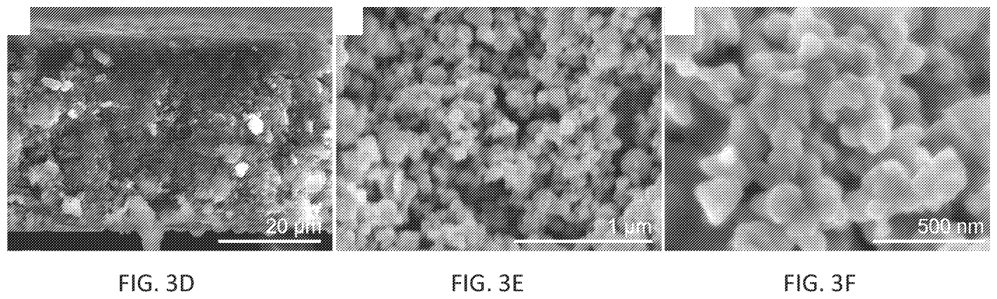

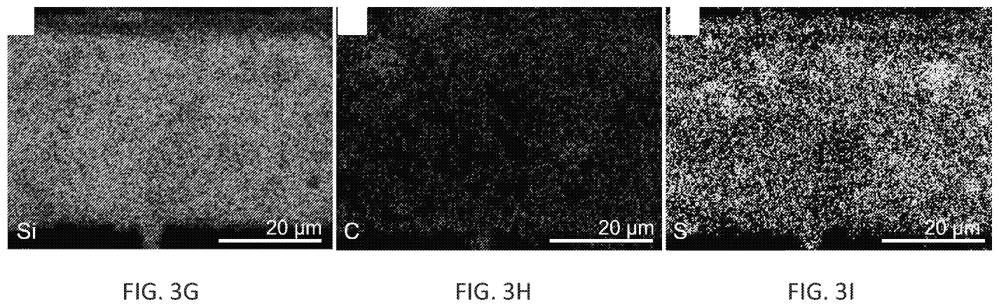

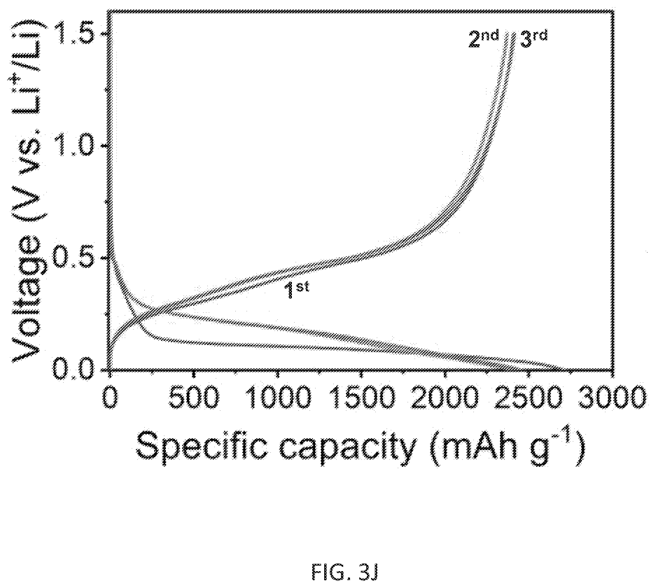

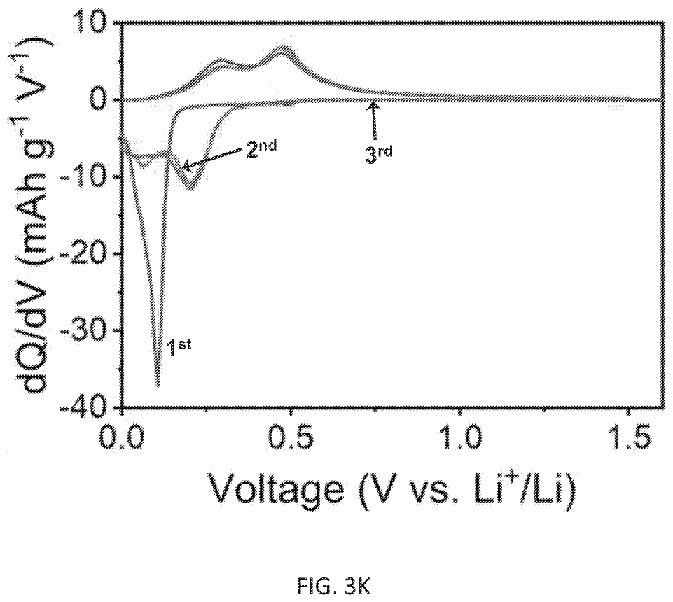

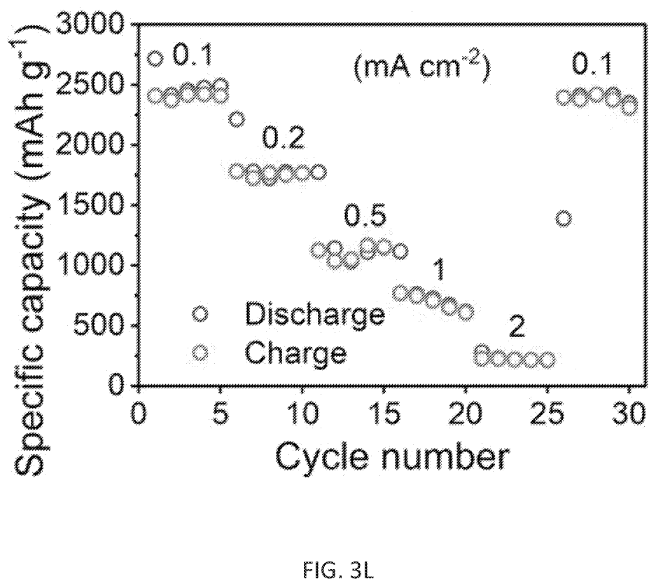

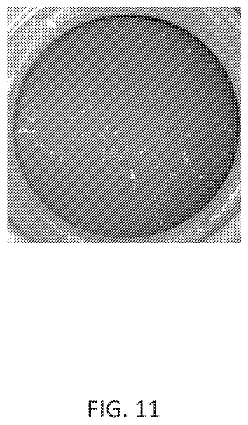

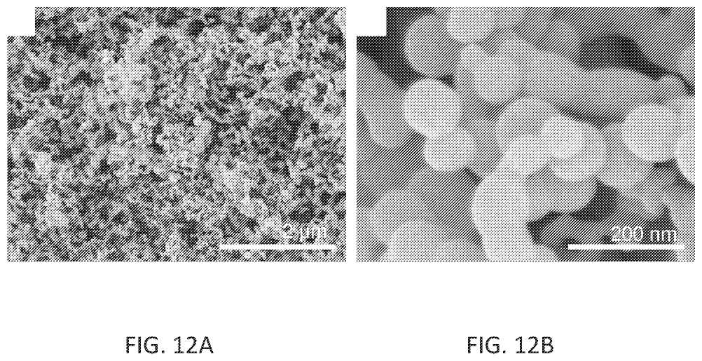

The anode layer was also investigated. FIG. 3A shows a photograph of the freestanding anode layer. The anode is comprised of nano Si, Li₆PS₅Cl, and carbon black in a weight ratio of 6:3:1. Due to the larger surface area of nano Si and carbon black than the cathode layer, the anode layer needed 4.0 wt % of ethyl cellulose to achieve good film formability and mechanical strength. The 2.0 wt. % ethyl cellulose anode layer was broken in the filtration process (FIG. 11). The mass loading of the anode layer was about 4 mg cm-2. The XRD patterns of the anode layer shown in FIG. 3B all agreed with Si and Li₆PS₅Cl, evidencing the filtration process had no side reactions. The anode layer delivered a high tensile strength of 562 kPa, as depicted in FIG. 3C, which demonstrated its excellent processibility in the following full cell fabrication. FIGS. 3D-F show the cross-section SEM images of the anode layer. The anode layer had a uniform thickness of about 50 μm. The Si nanoparticles have an average particle size of about 100 nm and were aggregated into clusters, as shown in FIGS. 12A-B. After the ball milling, the Si nanoparticles were uniformly mixed with the SE powder and carbon black. The EDX mapping of the anode layer, as shown in FIGS. 3G-I, indicated uniform mixing of the three components.

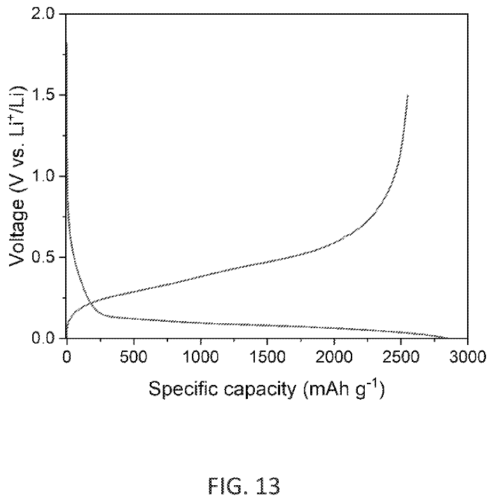

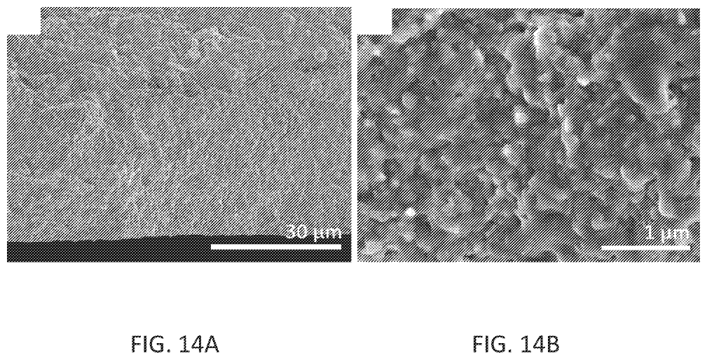

The electrochemical performance of the anode layer was investigated in the half-cell. FIG. 3J displays the charge and discharge profiles in the first three cycles at the current density of 0.1 mA cm⁻². High initial charge and discharge capacities of 2700 and 2412 mAh g-1 were achieved with a high ICE of 89.3%. In the following two cycles, the capacity was stable. FIG. 3K shows the corresponding dQ/dV profiles. The obvious difference in the discharge profiles between the initial and following cycles was caused by the amorphization of Si after the first cycle. The two couples of reversible peaks located at 0.204/0.471 and 0.059/0.296 V showed the transformations from different LixSi phases. The rate performance of the anode layer is shown in FIG. 3L. At current densities of 0.1, 0.2, 0.5, 1, and 2 mA cm⁻², the ASLB delivered average capacities of 2404, 1757, 1104, 695, and 220 mAh g¹. It showed that the addition of ethyl cellulose affected the rate performance of the anode layer significantly. When the cell was recharged at 0.1 mA cm⁻², the capacity recovered to 2375 mAh g⁻², demonstrating remarkable cycling stability. FIG. 13 shows the cross-section morphology of the anode layer after cycling. The anode became denser after cycling in comparison to the pristine anode. It has been reported that the Si anode experienced an amorphization during cycling. In addition, the lithiated Si (LixSi) has more deformation than pure Si. These explain the denser anode after cycling at a high stacking pressure. FIGS. 14A-B depicts the electrochemical performance of the composite anode without adding a binder. The ASLB delivered high discharge and charge capacities of 2841 and 2552 mAh g⁻¹ with a high ICE of 89.8%. Similar to the cathode, the addition of the binder also caused a capacity reduction to the anode resulting from the hindered ion conduction by the binder.

### Example 4: Characterization of the Mono Cell

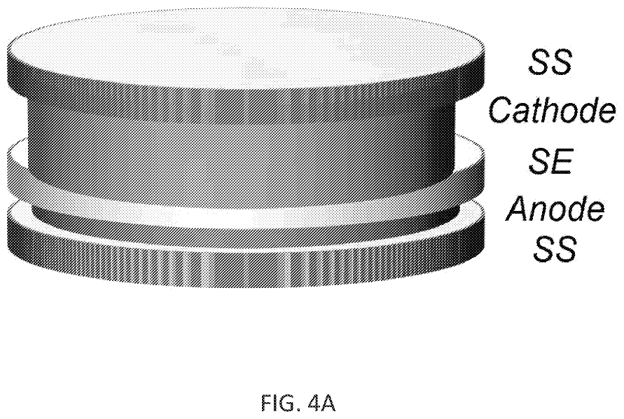

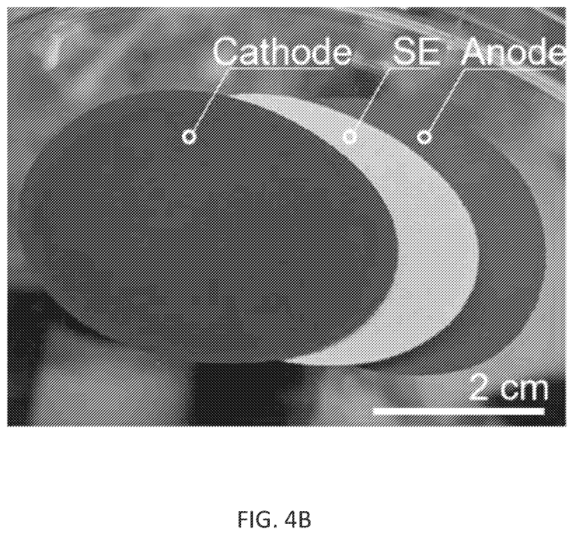

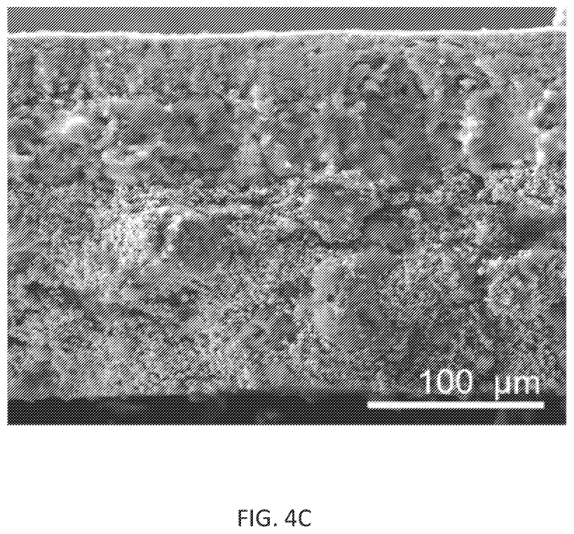

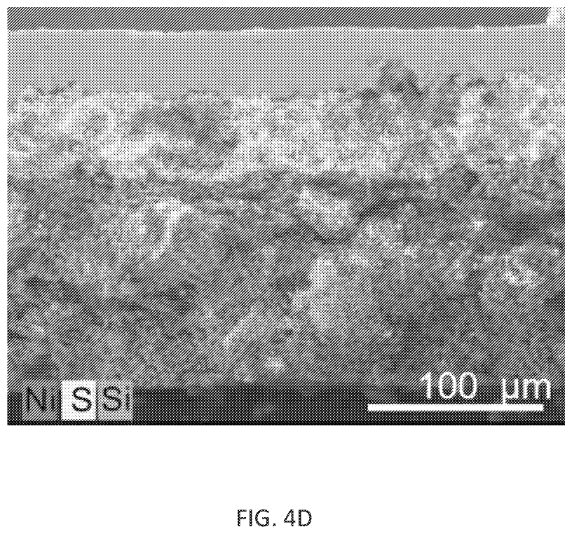

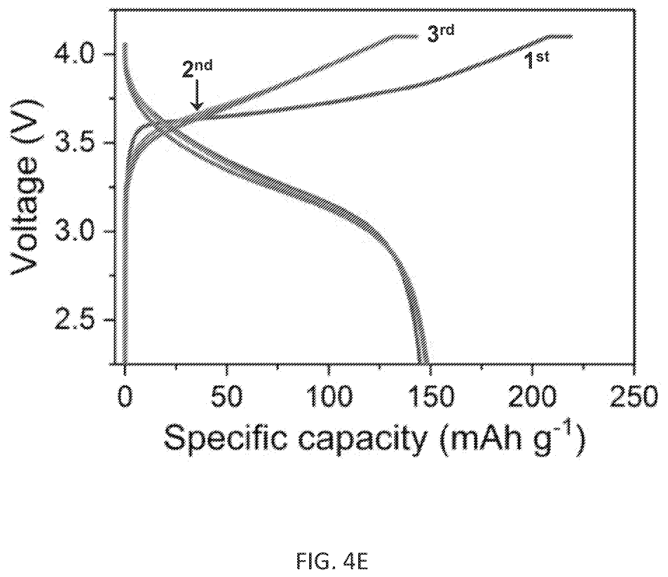

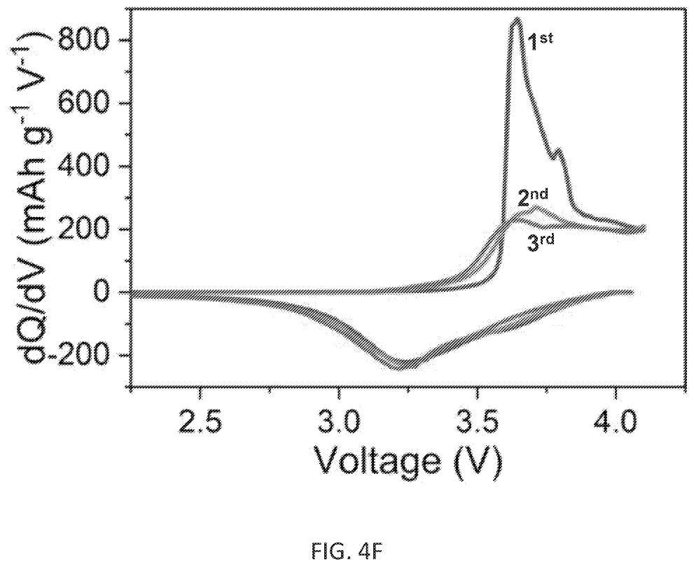

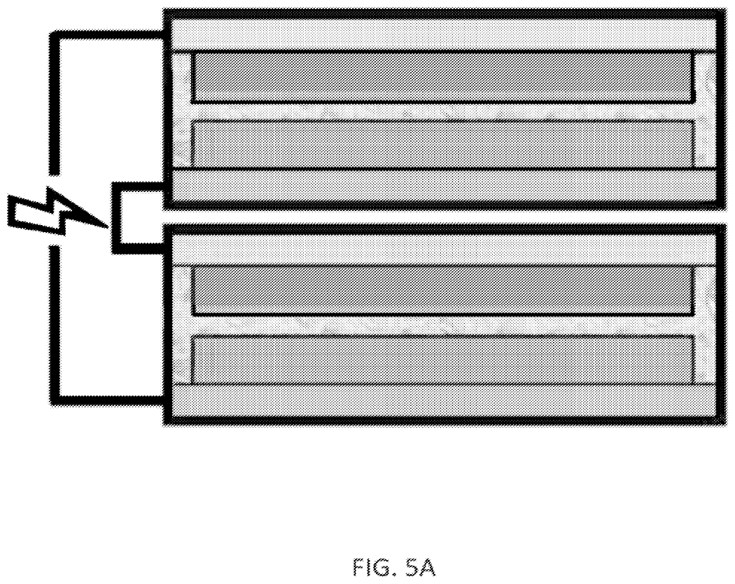

Then the mono cell was assembled by facilely stacking the SS current collector, cathode layer, SE layer, and anode layer one by one, as illustrated in FIG. 4A. A piece of freestanding SE membrane was utilized. The size of the SE was a little larger than the electrodes to avoid direct contact of electrodes when the cell was assembled. Stainless steel foil with a low thickness of about 10 μm was utilized as the current collector (or named monopolar plate) due to its superior electrochemical stability at both high and low potential. Under a uniaxial pressing, the stacked cathode, SE, and anode layers, as shown in FIG. 4B, were pressed together to fabricate the full cell. FIG. 4C displays the cross-section SEM image of the full cell in which a layer-by-layer structure was observed. Specifically, the SE layers are much denser than the cathode and anode layers, which avoided mechanical failure. The EDX mapping in FIG. 4D shows the element distribution in the three layers.

The mono cell was cycled at C/10 in the voltage range from 2.25 to 4.1 V. The n/p ratio was 1.45, calculated based on the half-cell performance. FIG. 4E displays the charge and discharge profiles at the first three cycles. A high initial discharge capacity of 145 mAh g-1 was achieved with an ICE of 68.2%. In the following two cycles, the profiles almost overlapped with the initial cycle which demonstrated good cycling stability. The corresponding dQ/dV profiles are depicted in FIG. 4F. Two pairs of anodic and cathodic peaks at 3.64 and 3.25, and 3.96 and 3.63 V were observed. The mono cell delivered high cell level gravimetric energy densities of 266 Wh kg⁻¹ and 189 Wh kg⁻¹ based on the mass with and without current collectors (see details in Table 1 below). The successfully assembled mono cell demonstrated the as-prepared cathode, SE, and anode layers have high processibility in cell fabrication.

TABLE 1
Parameters for the gravimetric energy
density calculation of the mono cell.

| | |
|---|---|
| Cathode (mg) | 31.5 |
| Cathode active material (mg) | 25 |
| Anode (mg) | 5 |
| Anode active material (mg) | 3 |
| Solid state electrolyte layer (mg) | 10 |
| Cell area (cm²) | 1.26 |
| Specific capacity_{CAM} (mAh g⁻¹) | 150 |
| Average voltage (V) | 3.28 |
| Stainless steel current collector (mg) | 9.5 |
| Gravimetric energy density (without current | 266 |
| collector) (Wh kg⁻¹) | |
| Gravimetric energy density (with current collector) | 189 |
| (Wh kg⁻¹) | |

Example 5: Characterization of Bipolar Stacked ASLB

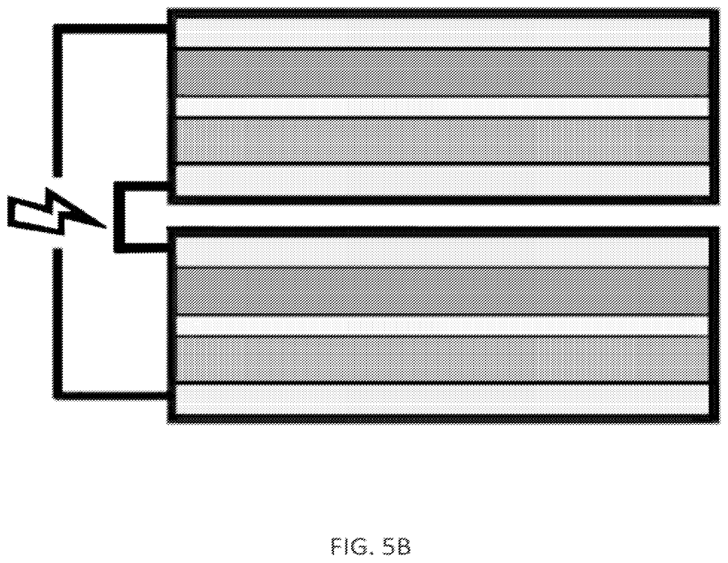

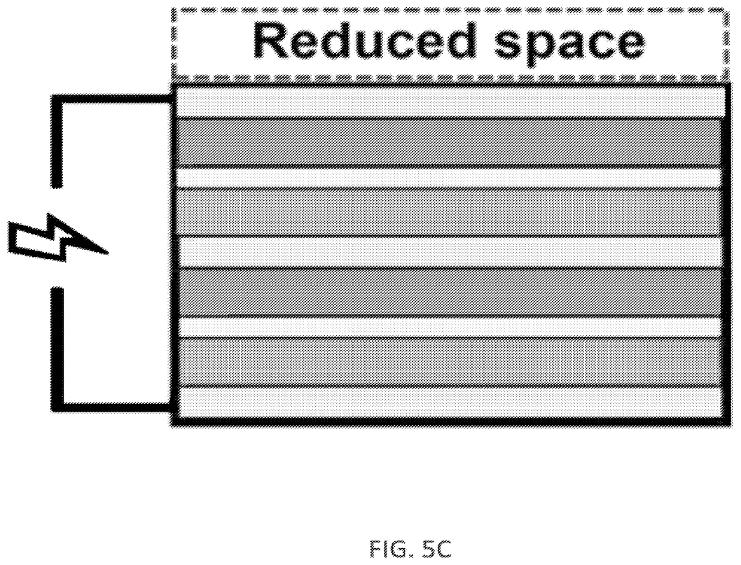

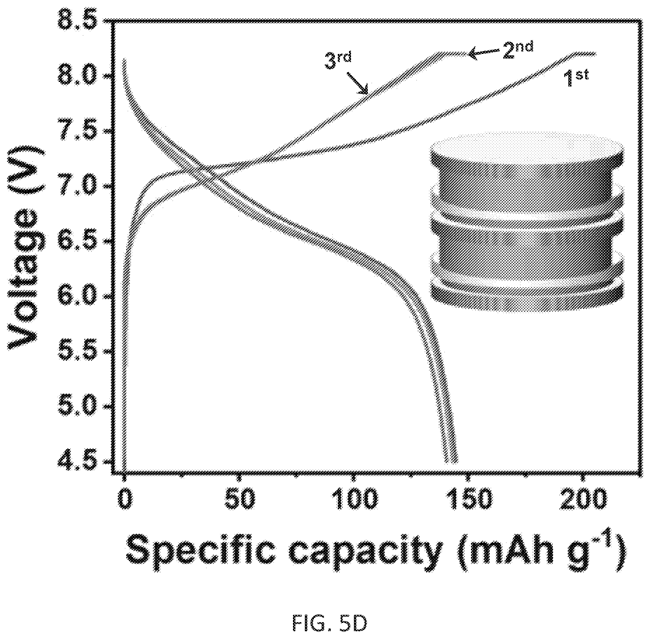

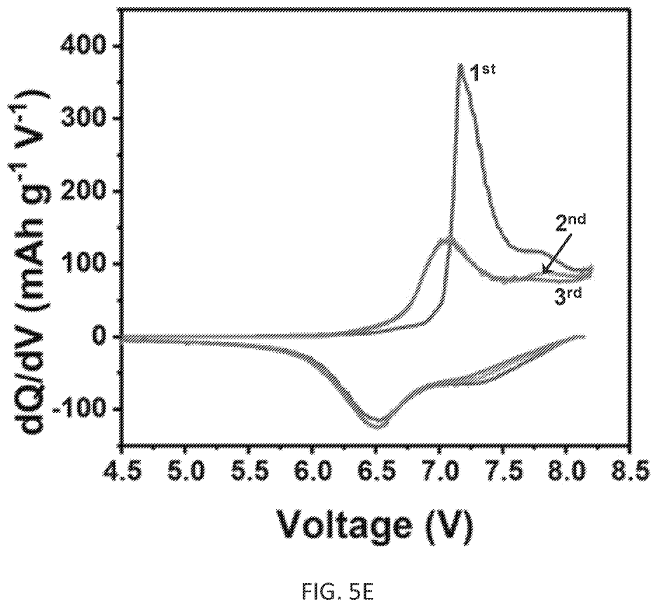

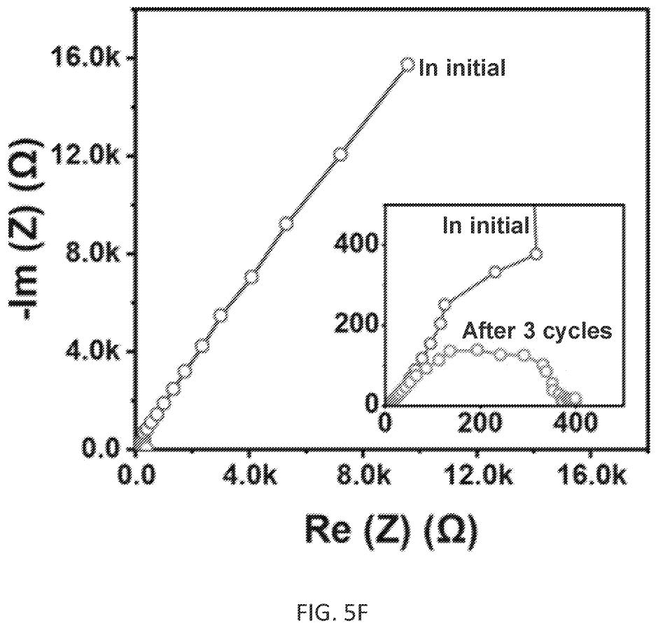

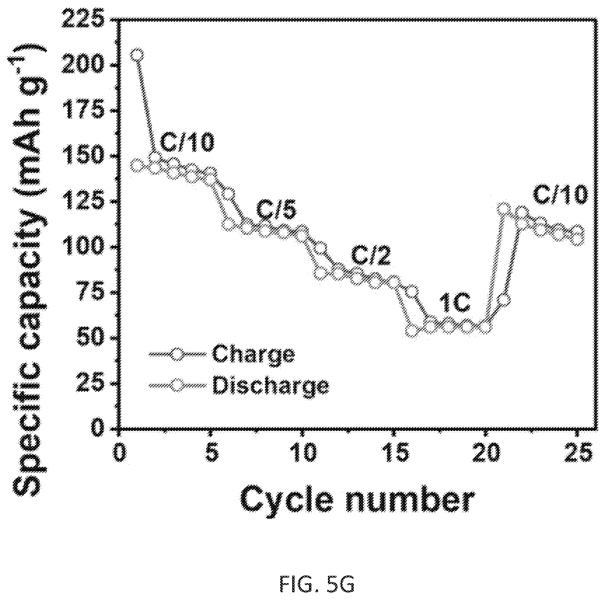

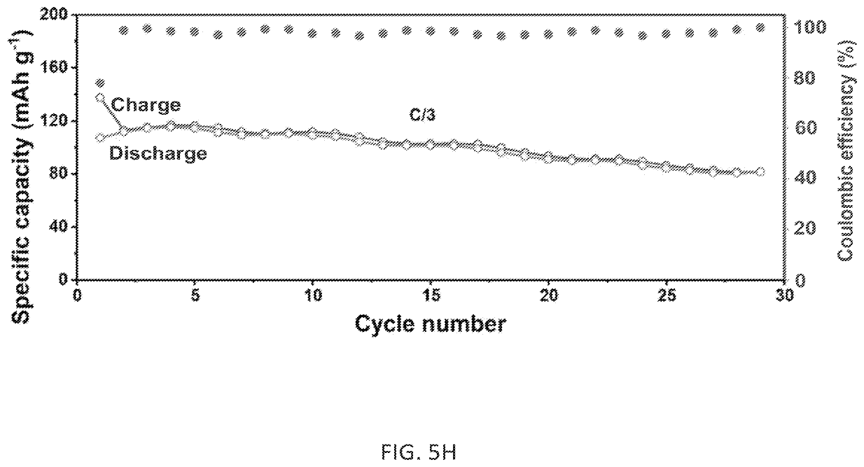

The freestanding electrodes and SE layers enabled the successful assembly of batteries series with a bipolar design. As shown in FIG. 5A, in conventional stacked LIBs using liquid electrolyte, the unit cells are packed separately. In contrast, ASLBs can successfully address these limitations. FIGS. 5B and 5C compare the ASLBs in conventional stacking and bipolar stacking. Considering the SE is not flowable, the adjacent cells can directly contact each other, and all the cells can be packed together. Moreover, the adjacent cells can share one current collector, and the fraction of inactive material is greatly reduced. All these merits of solid cells with bipolar design contribute to a packing level high energy.

FIG. 5D displays the charge/discharge profiles in the initial three cycles at C/10 of the bilayer cell. The cells were successfully assembled and operated in a voltage range from 4.5 V to 8.2 V. An obvious plateau during charge was observed at around 7.2 V, agreeing with the doubled value in the mono cell, which demonstrated good consistency between two cells. High charge and discharge capacities of 205 and 145 mAh g¹ were achieved with an ICE of 70.7%. FIG. 5E presents the differential capacities with cell potential. Similarly, there were two pairs of peaks at 7.17 and 6.53 V, 7.83 and 7.33 V, which were double to the mono cell, demonstrating the consistency of these two cells. FIG. 5F shows Nyquist plots of the ASLB in initial and after three cycles. In the initial, there was an incomplete semicircle and a Warburg tail. After three cycles, a depressed semicircle was observed with an impedance of about 400Ω, agreeing with that of the mono cell.

The rate performance was also evaluated. As shown in FIG. 5G, the cell delivered average specific capacities of 140, 110, 83, and 56 mAh g⁻¹ at C/10, C/5, C/2, and 1C, respectively. The cell level gravimetric energy density of the ASLBs reached 204 Wh kg⁻¹. The enhanced energy density compared with the mono cell was due to the smaller amounts of inactive materials. Another cell was assembled and measured at C/3, as depicted in FIG. 5H. A high initial capacity of 107 mAh g⁻¹ was obtained. After 30 cycles, the capacity maintained at 81 mAh g⁻¹. The capacity fluctuation was caused by the temperature difference during the day and night in the lab.

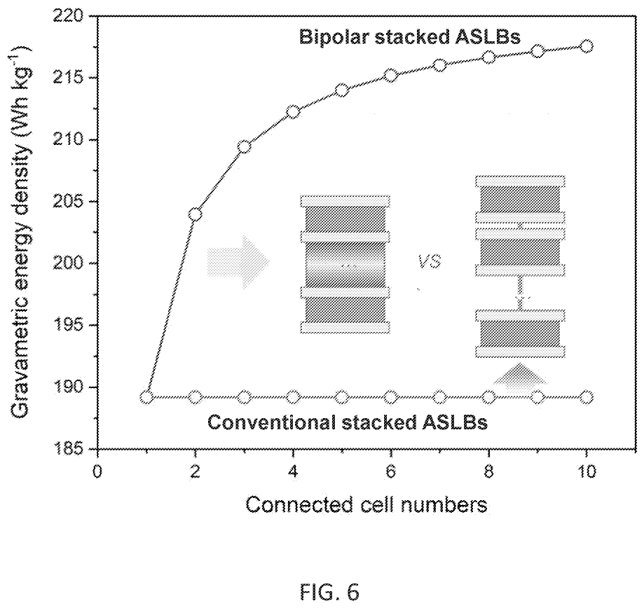

The advance of the bipolar cell was evident when increasing the number of stacked cells. The cell level gravimetric energy densities of the ASLBs with bipolar stacking and conventional stacking were evaluated in FIG. 6. The calculation was based on the battery performance of the mono cell. The adjacent mono cells in bipolar stacked ASLBs were assumed to share one current collector and were packed together, while the mono cells in conventional stacked ASLBs had individual current collectors and packing (see Table 2 below). The energy density of the ASLBs with bipolar stacking rose from 189 Wh kg⁻¹ to 217 Wh kg⁻¹ as the connected cell number increased to 10. In contrast, the energy density of the ASLBs had no relationship with the number of connected mono cells. The energy density enhancement in bipolar stacked ASLBs can be much higher when considering the mass of packing materials and the connections. It demonstrated that the bipolar stacked ASLBs have great potential to deliver higher energy density than the conventional stacked ASLBs.

TABLE 2
Gravimetric energy density evaluation of ASLBs with
the bipolar stacking and conventional stacking.

| Cell number | Bipolar stacking | Conventional stacking |
|---|---|---|
| 1 | 189.173 | 189.173 |
| 2 | 203.9546 | 189.173 |
| 3 | 209.4089 | 189.173 |
| 4 | 212.2469 | 189.173 |
| 5 | 213.9869 | 189.173 |
| 6 | 215.1628 | 189.173 |
| 7 | 216.0108 | 189.173 |
| 8 | 216.6511 | 189.173 |
| 9 | 217.1518 | 189.173 |
| 10 | 217.554 | 189.173 |

TABLE 3
Performance comparison with reported serially
bipolar stacked ASLBs using sulfide SEs.

| | | | Mono | | | | | |
|---|---|---|---|---|---|---|---|---|
| | | | cell | Energy | | Cathode | Anode | |
| | Cell | Cycle | voltage | density | | active | active | |
| No. | numbers | life | (V) | (Wh kg⁻¹) | SE | material | material | Ref. |
| 1 | 2 | 30 | 4.1 | 204 | Li₆PS₅Cl- | NMC 811 | Si | This |
| | | | | | Ethyl | | | work |
| | | | | | cellulose | | | |
| 2 | 2 | 1 | 3 | 44 | Li₃PS₄ | LCO | LTO | 28 |
| 3 | 3 | 1 | 4.2 | N/A | β-Li₃PS₄ | NMC 622 | Li | 29 |

### Example 6: Summary

In summary, higher energy density all solid-state batteries based on sulfide electrolyte were developed by employing high energy electrodes and unique bipolar stacking. In contrast to the conventional LiBs sealed separately and then packed together, the solid electrolyte (SE) enabled ASLBs to be directly connected without extra packing materials. The bipolar stacking design minimized the amount of inactive material in the batteries resulting in a significantly increased energy density. Moreover, since the batteries were connected in series, the high voltage output was obtained. Also, the shortened electron conduction paths between cells benefit lower resistance and increased power density.

Freestanding cathode, SE, and anode layers were fabricated through a facile vacuum filtration method based on an ethyl cellulose-toluene system. The cathode and anode layers showed considerable tensile strengths of 347 and 562 kPa, respectively, benefiting the fabrication of bipolar stacked ASLBs through facilely pressing the uniaxially stacked electrodes, SE, and current collector layers. A Li₂SiOₓ coated single-crystal LiNi_{0.8}Mn_{0.1}Co_{0.1}O₂ and nano Si worked as the cathode and anode active material, respectively. Both cathode and anode delivered remarkable capacities. When coupled the cathode and anode layers in a mono cell, a cell-level high energy density of 189 Wh kg⁻¹ (including current collectors) was obtained. In the bipolar-stacked double cell, the energy density was enhanced to 204 Wh kg⁻¹. This work sheds light on the significance of the bipolar design for ASLBs and accelerates the commercialization of ASLBs.

### Example 7. Preparation of LiPSsCl

As synthesized Li₆PS₅C1 was dispersed in toluene and ball milled for 5 hours at 400 rpm. The toluene was removed in vacuum. After that, a 200° C. heat treatment was applied to totally remove the toluene. The fine Li₆PS₅Cl powders were successfully prepared.

### Example 8: Li₂SiO.@S-NMC

The Li₂SiOₓ@S-NMC was prepared through a sol gel method. Tetraethyl orthosilicate (TEOS, Sigma-Aldrich, 99.0%), Lithium (Li, Sigma-Aldrich, 99.9%), anhydrous ethanol (Sigma-Aldrich), and single-crystal NMC 811 (Nanoramic Inc.) were utilized as received. 3.1 mg of Li was added in 1.2 mL ethanol. After all Li was consumed, 50 μL of TEOS was added with stirring for 10 min at 300 rpm. Then 1 g of S-NMC powder was added in the solutions with stirring for 1 hour at 300 rpm. The ethanol was removed in a vacuum, and a bath sonication was applied to avoid the aggregation of S-NMC. The dried sample was then heated at 350° C. for 2 hours in a muffle furnace with ambient air. The Li₂SiOₓ@S-NMC was collected and stored in the glovebox for further use.

### Example 9: Preparation of Cathode Layer

The cathode layer was prepared through a vacuum filtration method in the glovebox. 3 mg of ethyl cellulose (Sigma-Aldrich) was dissolved in 2 mL of toluene at 50° C. Then 60 mg Li₆PS₅C1 powders were added with stirring for 1 hour at 300 rpm. After the Li₆PS₅C1 was well dispersed, 237 mg of Li₂SiOₓ@S-NMC was added with stirring for 1 hour at 300 rpm. The dispersion was then cast in the vacuum filtration system with a diameter of 47 mm. After the visible solvent was removed, a freestanding thin membrane could then be peeled off from the filter paper. The membrane was then heated at 150° C. for 12 hours to totally remove the residual toluene. The cathode layer was obtained.

### Example 10: Preparation of Anode Layer

The anode layer was fabricated with similar method as the cathode layer preparation. 180 mg of Si powder, 90 mg of Li₆PS₅Cl, and 30 mg of carbon black were mixed in an Argon-filled milling jar (50 mL) at 300 rpm for 5 hours. 2 g of ZrO2 milling balls (4 mm in diameter) were utilized. The Si-SE-CB was obtained. 3 mg of ethyl cellulose was first dissolved in 2 mL of toluene at 50° C. Then 72 mg of Si-SE-CB was added with continuous stirring for 1 hour at 300 rpm. The dispersion was then cast on the vacuum filtration system. The freestanding anode layer was finally obtained after peeling off from the filter paper and heated at 150° C. for 12 hours.

### Example 11: Materials Characterization

The XRD was performed on PANalytical/Philips X'Pert Pro (PANalytical, Netherlands) with Cu Ka radiation. A Kapton tape was used to seal the sample. The SEM and EDX mapping were conducted on SEM JEOL JSM 7000F (JEOL Ltd., Japan). The tensile strength was measured on a HR 30 Discovery Hybrid Rheometer-dynamic mechanical analysis (DMA) (TA Instruments, USA). The cathode and anode layers were cut into strips with lengths of 3 cm and widths of 5 mm. The displacement speed was 0.01 mm s⁻¹.

### Example 12: Fabrication of Half-Cell

All the cells were fabricated in a homemade pressurized cell. For the half cell, 200 mg Li₆PS₅Cl was placed in a PEEK-made mold and applied a pressure of 300 MPa. Then one piece of electrode (cathode or anode) layer was placed on one side, and a piece of In-Li foil was attached in the other side. The cell was then pressed at the pressure of 100 MPa. Cu foil was used as the current collector for both sides. An external pressure of 50 MPa was applied to the cell during cycling.

### Example 13: Fabrication of Full Cell

The full cell was assembled in a similar method with half-cell. For the mono cell, stainless steel foil, cathode layer, SE layer, anode layer and stainless steel foil were stacked in sequence in a PEEK-made mold. Then an axial pressure of 300 MPa was applied to the cell for 10 min. An external pressure of 50 MPa was applied in the cell during cycling. For the doubly stacked cells, stainless steel foil, cathode layer, SE layer, anode layer, stainless steel foil, cathode layer, SE layer, anode layer, and stainless steel foil were stacked in the mold in sequence. After a pressure of 300 MPa was applied, the bipolar stacked ASLBs were successfully assembled.

### Example 14: Electrochemical Measurement

The anode half-cell was measured in a galvanostatic charge/discharge at current density of 0.1, 0.2, 0.5, 1, and 2 mA cm⁻² in the voltage range between −0.6 to 0.9 V (vs. In-Li). The mass loading was around 4 mg cm⁻². The cathode half-cell was measured in a protocol that the cell was charged at constant current to 3.8 V (vs. In-Li), held at 3.8 V for 1 h, then discharged to 2.0 V (vs. In-Li). The current was set based on the theoretical capacity of NMC for 200 mAh g⁻¹. The mono cell was measured in a similar way in that the cell was charged at constant current to 4.1 V, held at 4.1 V for 1 h, then discharged to 2.25 V. The current was set based on the theoretical capacity of NMC for 200 mAh g⁻¹. The bipolar stacked double-layer cell was charged at constant current to 8.2 V, held at 8.2 V for 1 h, then discharged to 4.5 V. The current was set based on the theoretical capacity of NMC for 200 mAh g¹.

### REFERENCES

1. Wang, C., et al., All-solid-state lithium batteries enabled by sulfide electrolytes: from fundamental research to practical engineering design. Energy & Environmental Science, 2021. 14(5): p. 2577-2619.
2. Zhang, Q., et al., Sulfide-Based Solid-State Electrolytes: Synthesis, Stability, and Potential for All-Solid-State Batteries. Advanced Materials, 2019. 31(44): p. 1901131.
3. Paul, P. P., et al., Interfaces in all solid state Li-metal batteries: A review on instabilities, stabilization strategies, and scalability. Energy Storage Materials, 2022. 45: p. 969-1001.
4. Zhang, H., et al., Electrolyte and anode-electrolyte interphase in solid-state lithium metal polymer batteries: A perspective. SusMat, 2021. 1(1): p. ²⁴-3⁷.
5. Gambe, Y., Y. Sun, and I. Honma, Development of Bipolar All-solid-state Lithium Battery Based on Quasi-solid-state Electrolyte Containing Tetraglyme-LiTFSA Equimolar Complex. Scientific Reports, 2015. 5(1): p. 8869.
6. Schnell, J., et al., All-solid-state lithium-ion and lithium metal batteries—paving the way to large-scale production. Journal of Power Sources, 2018. 382: p. 160-175.
7. Yamamoto, M., et al., Binder-free sheet-type all-solid-state batteries with enhanced rate capabilities and high energy densities. Scientific Reports, 2018. 8(1): p. 1212.
8. Famprikis, T., et al., Fundamentals of inorganic solid-state electrolytes for batteries. Nature Materials, 2019. 18(12): p. 1278-1291.
9. Chen, Y., et al., Recent progress in all-solid-state lithium batteries: The emerging strategies for advanced electrolytes and their interfaces. Energy Storage Materials, 2020. 31: p. 401-433.
10. Wei, Z., et al., Superior lithium ion conduction of polymer electrolyte with comb-like structure via solvent-free copolymerization for bipolar all-solid-state lithium battery. Journal of Materials Chemistry A, 2018. 6(27): p. 13438-13447.
11. Wei, Z., et al., A large-size, bipolar-stacked and high-safety solid-state lithium battery with integrated electrolyte and cathode. Journal of Power Sources, 2018. 394: p. 57-66.
12. Shin, H.-S., et al., Multilayered, Bipolar, All-Solid-State Battery Enabled by a Perovskite-Based Biphasic Solid Electrolyte. ChemSusChem, 2018. 11(18): p. ³¹⁸⁴-3¹⁹⁰.
13. Yoshima, K., Y. Harada, and N. Takami, Thin hybrid electrolyte based on garnet-type lithium-ion conductor Li₇La₃Zr₂O₁₂ for 12 V-class bipolar batteries. Journal of Power Sources, 2016. 302: p. 283-290.
14. Chen, X., et al., Enhancing interfacial contact in all solid state batteries with a cathode-supported solid electrolyte membrane framework. Energy & Environmental Science, 2019. 12(3): p. 938-944.
15. Lee, J., et al., A Nanophase-Separated, Quasi-Solid-State Polymeric Single-Ion Conductor: Polysulfide Exclusion for Lithium-Sulfur Batteries. ACS Energy Letters, 2017. 2(5): p. 1232-1239.
16. Homann, G., et al., High-Voltage All-Solid-State Lithium Battery with Sulfide-Based Electrolyte: Challenges for the Construction of a Bipolar Multicell Stack and How to Overcome Them. ACS Applied Energy Materials, 2020. 3(4): p. 3162-3168.
17. Cao, D., et al., Amphipathic Binder Integrating Ultrathin and Highly Ion-Conductive Sulfide Membrane for Cell-Level High-Energy-Density All-Solid-State Batteries. Advanced Materials. n/a(n/a): p. 2105505.
18. Tan, D. H. S., et al., Carbon-free high-loading silicon anodes enabled by sulfide solid electrolytes. Science, 2021. 373(6562): p. 1494-1499.
19. Wang, C., et al., Interface-assisted in-situ growth of halide electrolytes eliminating interfacial challenges of all-inorganic solid-state batteries. Nano Energy, 2020. 76: p. 105015.
20. Wu, J., et al., All-Solid-State Lithium Batteries with Sulfide Electrolytes and Oxide Cathodes. Electrochemical Energy Reviews, 2021. 4(1): p. 101-135.
21. Cao, D., et al., Stable Thiophosphate-Based All-Solid-State Lithium Batteries through Conformally Interfacial Nanocoating. Nano Letters, 2020. 20(3): p. 1483-1490.
22. Dong, X., et al., Enhanced high-voltage cycling stability of Ni-rich cathode materials via the self-assembly of Mn-rich shells. Journal of Materials Chemistry A, 2019. 7(35): p. 20262-20273.
23. Zhu, B., et al., Towards high energy density lithium battery anodes: silicon and lithium. Chemical Science, 2019. 10(30): p. 7132-7148.
24. Wang, S., et al., High-Conductivity Argyrodite Li₆PS₅C1 Solid Electrolytes Prepared via Optimized Sintering Processes for All-Solid-State Lithium-Sulfur Batteries. ACS Applied Materials & Interfaces, 2018. 10(49): p. 42279-42285.
25. Datta, M. K. and P. N. Kumta, In situ electrochemical synthesis of lithiated silicon-carbon based composites anode materials for lithium ion batteries. Journal of Power Sources, 2009. 194(2): p. 1043-1052.
26. Nam, Y. J., et al., Bendable and thin sulfide solid electrolyte film: a new electrolyte opportunity for free-standing and stackable high-energy all-solid-state lithium-ion batteries. Nano letters, 2015. 15(5): p. 3317-3323.
27. Cao, D., et al., Stable Thiophosphate-Based All-Solid-State Lithium Batteries through Conformally Interfacial Nanocoating. Nano Letters, 2020. 20(3): p. 1483-1490.
28. Nam, Y. J., et al., Bendable and Thin Sulfide Solid Electrolyte Film: A New Electrolyte Opportunity for Free-Standing and Stackable High-Energy All-Solid-State Lithium-Ion Batteries. Nano Letters, 2015. 15(5): p. 3317-3323.
29. Homann, G., et al., High-Voltage All-Solid-State Lithium Battery with Sulfide-Based Electrolyte: Challenges for the Construction of a Bipolar Multicell Stack and How to Overcome Them. ACS Applied Energy Materials, 2020. 3(4): p. 3162-3168.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. An all-solid-state battery comprising two or more mono cells connected in series, wherein:
each mono cell comprises a lithium-based cathode, a sulfide solid electrolyte, and an anode; and
adjacent mono cells are connected through a single, shared current collector in contact with a cathode and an anode of adjacent mono cells.

2. The all-solid-state battery of claim 1, wherein the two or more mono cells are arranged uniaxially.

3. The all-solid-state battery of claim 1, wherein the lithium-based cathode, the sulfide solid electrolyte, the anode, the shared current collector, or any combination thereof, is in the form of a layer.

4. The all-solid-state battery of claim 1, wherein the lithium-based cathode has a thickness of about 50 μm to about 200 μm, or wherein the lithium-based cathode has a thickness of about 96 μm.

5. (canceled)

6. (canceled)

7. The all-solid-state battery of claim 1, wherein the sulfide solid electrolyte has a thickness of about 20 μm to about 1 millimeter, or wherein the sulfide solid electrolyte has a thickness of about 47 μm.

8. (canceled)

9. (canceled)

10. The all-solid-state battery of claim 1, wherein the anode has a thickness of about 20 μm to about 100 μm, or wherein the anode has a thickness of about 50 μm.

11. (canceled)

12. (canceled)

13. The all-solid-state battery of claim 1, wherein the shared current collector has a thickness of about 10 μm to about 50 μm, or wherein the shared current collector has a thickness of about 15 μm.

14. (canceled)

15. The all-solid-state battery of claim 1, wherein lateral size of the sulfide solid electrolyte is greater than lateral size of the lithium-based cathode and lateral size of the anode.

16. The all-solid-state battery of claim 1, wherein the shared current collector is carbon paper or stainless steel.

17. (canceled)

18. The all-solid-state battery of claim 1, wherein:
(a) the lithium-based cathode comprises single-crystal LiNi_{0.8}Mn_{0.1} Co_{0.1}O₂ coated with Li₂SiOₓ, wherein x is about 1 to about 3,
(b) the sulfide solid electrolyte comprises Li₆PS₅Cl,
(c) the anode comprises a mixture of nano-silicon (Si), Li₆PS₅Cl, and carbon black, or
(d) any combination thereof.

19. The all-solid-state battery of claim 1, wherein the lithium-based cathode, the sulfide solid electrolyte, the anode, or any combination thereof, further comprises an amphipathic binder.

20. (canceled)

21. (canceled)

22. (canceled)

23. The all-solid-state battery of claim 1, wherein the anode comprises a mixture of nano-silicon (Si), Li₆PS₅Cl, and carbon black having a weight ratio of about 6:3:1.

24. (canceled)

25. The all-solid-state battery of claim 19, wherein the amphipathic binder is alkyl cellulose or ethyl cellulose.

26. (canceled)

27. The all-solid-state battery of claim 1, further comprising an anode current collector in contact with an anode of a first mono cell in series, and a cathode current collector in contact with a cathode of a last mono cell in series.

28. A mono cell all-solid-state battery comprising first and second stainless steel current collectors, a cathode comprising single-crystal LiNi_{0.8}Mn_{0.1}Co_{0.1}O₂ coated with Li₂SiOₓ, wherein x is about 1 to about 3, a sulfide solid electrolyte, and an anode, wherein the first stainless steel current collector is in contact with the cathode, the cathode is in contact with the sulfide solid electrolyte, the sulfide solid electrode is in contact with the anode, and the anode is in contact with the second stainless steel current collector.

29. A system comprising an all-solid-state battery of claim 1 connected to an energy source or an electrical device.

30. A method of fabricating a lithium-based cathode, comprising:
a) providing a dispersion of an amphipathic binder, Li₆PS₅Cl, single-crystal LiNi_{0.8}Mn_{0.1}Co_{0.1}O₂ coated with Li₂SiOₓ wherein x is about 1 to about 3 in a solvent; and
b) vacuum filtering the dispersion through a filter, thereby forming a layer of lithium-based cathode.

31. The method of claim 30, wherein the solvent is an organic solvent, wherein the amphipathic binder is ethyl cellulose, or wherein the solvent is an organic solvent and the amphipathic binder is ethyl cellulose.

32. (canceled)

33. The method of claim 30, wherein the amphipathic binder is about 1.0 weight percent (wt. %) to about 3.0 wt. % of the dispersion or wherein the amphipathic binder is about 1.0 wt. % of the dispersion.

34. (canceled)

35. The method of claim 30, further comprising;
(a) removing the layer of lithium-based cathode from the filter to form a freestanding layer of lithium-based cathode,
(b) evaporating the solvent from the layer of lithium-based cathode or freestanding layer of lithium-based cathode, or
(c) both (a) and (b).

36. (canceled)

37. A method of fabricating an anode, comprising:
a) providing a dispersion of an amphipathic binder, Si, Li₆PS₅Cl, and carbon black in a solvent; and
b) vacuum filtering the dispersion through a filter, thereby forming a layer of anode.

38. The method of claim 37, wherein the solvent is an organic solvent, wherein the amphipathic binder is ethyl cellulose, or wherein the solvent is an organic solvent and the amphipathic binder is ethyl cellulose.

39. (canceled)

40. The method of claim 37, wherein the ethyl cellulose is about 1.0 wt. % to about 5.0 wt. % of the dispersion, or wherein the ethyl cellulose is about 1.0 wt. % of the dispersion.

41. (canceled)

42. The method of claim 37, further comprising:
(a) removing the layer of anode from the filter to form a freestanding layer of anode,
(b) evaporating the solvent from the layer of anode or freestanding layer of anode or
(c) both (a) and (b).

43. (canceled)

44. A method of fabricating the all-solid-state battery of claim 1, the method comprising stacking freestanding layers of the lithium-based cathode, the sulfide solid electrolyte, the anode, and the current collector in a bipolar design, and pressing the layers together to form the all-solid-state battery.
